(19) United States
(12) Patent Application Publication
(10) Pub. No.: US 2002/0114968 A1
(43) Pub. Date: Aug. 22, 2002

(54) Dimensionally stable laminate and method of preparation

(75) Inventors: Yvette A. Tramount, Charleston, SC (US); Edward P. Klein, Goose Creek, SC (US)

Correspondence Address: Terry B. McDaniel, Westvaco Corporation, 5255 Virginia Avenue, P. O. Box 118005, Charleston, SC, 29423-8005, US

(73) Assignee: Westvaco Corporation, New York, NY (US)

(21) Appl. No.: 10/074,731

(22) Filed: Feb. 13, 2002

Related U.S. Application Data
(62) Division of application No. 09/289,712, filed on Apr. 12, 1999.
Application No. 09/289,712 is a continuation-in-part of application No. 08/784,407, filed on Jan. 16, 1997, now abandoned.

(51) Int. Cl. B32B 29/00; B32B 27/42

(52) U.S. Cl. 428/537.5; 428/530; 156/335

(57) ABSTRACT

The disclosed invention is a dimensionally stable laminate prepared by layering resin saturable sheets, treating the layered sheets with a polymeric resin, pressing the treated layered sheets together under high pressure and high temperature to form a laminate and then subjecting the newly manufactured laminate to high humidity (greater than 65%) at relatively low temperatures (32°-45° C.) before exposure to ambient conditions.

### BACKGROUND OF THE INVENTION

1. Field of the Invention

This invention relates to laminates prepared by layering sheets of resin saturable papers and treating the layered sheets with heat curable resins and pressing the layered treated sheets under high pressure and high temperature. More particularly, this invention relates to improvements in the dimensional stability properties of laminates generally and decorative laminates in particular. The invention further relates to subjecting the laminates to a post-formation treatment to improve dimensional stability in its final application, or use.

2. Description of Related Art (Including Information Disclosed Under 37 CFR 1.97 and 37 CFR 1.98)

Special, resin saturable papers are manufactured to be used in the manufacture of laminates. Such laminates are typically comprised of an assembly of layers: a core layer and a surface layer for industrial laminates and a core layer, a print layer, and a surface layer for decorative laminates. The core layer comprises a bottom or supporting layer onto which the other layers are bonded. In conventional high-pressure laminate manufacture, the core layer consists of a plurality of cellulosic sheets, e.g., resin impregnated kraft paper. The number of sheets used in the core layer may vary from about 1 to about 9, e.g., 3 to 8 sheets. Superimposed above the core layer in decorative laminates is the print layer, which generally is an alpha cellulose pigmented paper containing a print, pattern or design that has been impregnated with a melamine-formaldehyde resin. The surface layer or overlay sheet, as it is commonly called, is typically a high quality alpha cellulose paper impregnated with a melamine-formaldehyde resin. This layer protects the print sheet from external abuse, such as abrasion wear and tear, harsh chemicals, bums, spills, and the like.

In preparing the laminate, the layers are stacked in a superimposed relationship, the resulting bundle of sheets are placed between polished steel plates and are subjected to above atmospheric pressure and above ambient temperature for a time sufficiently long to cure the laminating resins impregnating the respective layers. Temperatures from about 120° C. to about 300° C. are typically used. Decorative laminates may be prepared using both high and low pressure. High pressure laminates are typically formed using from about 700 to about 1600 pounds per square inch (psi) pressure (4.8- 11 Mpa), e.g., 1000 psi (6.9 Mpa).

Laminates, particularly high pressure laminates, find utility in the manufacture of furniture, kitchen countertops, table tops, store fixtures, flooring, wall paneling, partitions, doors, wallpaper, and bathroom, kitchen, and other work surfaces.

Dimensional stability, warm water adsorption, and flexibility are some of the key laminate properties which relate to these uses and which are controlled by the properties of the paper.

Laminates have serious problems of dimensional instability under variable humidity and temperature conditions. This instability manifests itself by a pronounced tendency of the structure to warp, or curl, and, under certain conditions, by an apparent increase in stiffness.

Conventionally, after being formed in a press a decorative laminate is stored at ambient conditions before installation in its final application. During its life cycle, the laminate expands and contracts many times with changes in relative humidity. This may create problems of performance in the particular use made of the laminate, such as in furniture, such as counter tops, or flooring. The object of the instant invention is to provide a method of treating the laminate to reduce its overall dimensional change, both in the machine direction (MD) and the cross direction (CD), during humidity cycling (as compared to a laminate that has not been so treated before use) to enhance performance and longevity of the laminate in a particular application.

### SUMMARY OF THE INVENTION

The object of the invention is met by preparing a laminate by layering resin saturable sheets, treating the layered sheets with a polymeric resin, pressing the treated layered sheets together under high pressure (>800 psi) and high temperature (>120° C.) to form the laminate and then subjecting the newly manufactured laminate to high relative humidity (greater than 65%) at relatively low temperatures (32°-45° C.) for a period greater than 24 hours (at atmospheric pressure) before exposure to ambient conditions.

### BRIEF DESCRIPTION OF THE DRAWINGS

FIG. 1 is a graphical depiction of dimensional change of “new” laminates prepared from 92# (per 3,000 ft²) resin saturable paper in both the CD and MD versus water absorption after extreme humidity exposures beginning with high humidity (after conditioning at 50%). Subsequent to the shrinkage resulting from the initial high humidity exposure, shrinkage was reduced in subsequent exposures to about 50% in the CD and by about 58% in the MD.

FIG. 2 is a graphical depiction of dimensional change of “old” laminates prepared from 92# resin saturable paper in both the CD and MD versus water absorption after extreme humidity exposures beginning with high humidity (after conditioning at 50% humidity). Subsequent to the shrinkage resulting from the initial high humidity exposure, shrinkage was reduced in subsequent exposures to about 62% in the CD and by about 58% in the MD.

FIG. 3 is a graphical depiction of dimensional change of “new” laminates prepared from 137# (per 3,000 ft²) resin saturable paper in both the CD and MD versus water absorption after extreme humidity exposures beginning with high humidity (after conditioning at 50%). Subsequent to the shrinkage resulting from the initial high humidity exposure, shrinkage was reduced in subsequent exposures to about 5% in the CD and by about 44% in the MD.

FIG. 4 is a graphical depiction of dimensional change of “old” laminates prepared from 137# resin saturable paper in both the CD and MD versus water absorption after extreme humidity exposures beginning with high humidity (after conditioning at 50%). Subsequent to the shrinkage resulting from the initial high humidity exposure, shrinkage was reduced in subsequent exposures to about 55% in the CD and by about 44% in the MD.

FIG. 5 is a graphical depiction of dimensional change of “new” laminates prepared from 92# resin saturable paper in both the CD and MD versus water absorption after extreme humidity exposures beginning with low humidity (after conditioning at 50%).

FIG. 6 is a graphical depiction of dimensional change of “old” laminates prepared from 92# resin saturable paper in both the CD and MD versus water absorption after extreme humidity exposures beginning with low humidity (after conditioning at 50%).

FIG. 7 is a graphical depiction of dimensional change of “new” laminates prepared from 137# resin saturable paper in both the CD and MD versus water absorption after extreme humidity exposures beginning with low humidity (after conditioning at 50%).

FIG. 8 is a graphical depiction of dimensional change of “old” laminates prepared from 137# resin saturable paper in both the CD and MD versus water absorption after extreme humidity exposures beginning with low humidity (after conditioning at 50%).

FIG. 9 is a bar graph of the data presented in Table I showing the shrinkage of laminates after extreme humidity exposures.

### DESCRIPTION OF THE PREFERRED EMBODIMENT(S)

Although few solutions have been suggested to solve the problem of laminate warpage resulting from environmental exposure, the problem has been recognized and investigated.

Studies by Epstein et al. on “The Effect of Moisture on Phenolic Resin-Kraft Paper Moldings,” Third Decorative Laminate Seminar, Hilton Head, S.C., May 10-12, 1967 (also published as “Factors Affecting the Environmental Stability of Laminates” in Applied Polymer Symposia No. 4, at 219-243, (1967)) confirmed the anisotropic behavior of laminates. Qualitatively, the environmental instability of laminates can be said to be, in part, a measure of the relative degree of its paper-like quality. Thus, percentage-wise, a wet fiber will swell to the greatest extent in its thickness and the least in its length. Likewise, in a sheet of paper, the largest dimensional change is in the thickness, the next largest is in the cross-fiber (transverse) direction, and the smallest is in the machine direction. The laminate follows this pattern also. Since thickness changes do not cause curvature, or warping, the relationship between the longitudinal and lateral dimensional changes is the critical factor. The studies by Epstein et al. were conducted at relative humidities of 10%, 50%, and 98% and at relatively high temperature (73° C.).

One suggested solution is offered by Shiflet in U.S. Pat. No. 4,126,725 (1978) which describes improving the dimensional stability of decorative laminates by the inclusion of foraminous steel foil layers to resist shrinkage of the melamine layer. The decorative laminate so improved is comprised of a plurality of layers and adhesive means rigidly securing sail layers together to provide a self-sustaining laminate. The layers include a plurality of phenolic layers and a synthetic resin (melamine)-containing layer having a tendency to shrink under conditions of low humidity thereby tending to cause deformation of the laminate. More specifically, the disclosed improvement involves including two steel foil layers (each layer being˜0.002 inch in thickness) with both steel foil layers being on the same side of the melamine layer but being separated from each other by at least one of the phenolic layers. Basically, this solution involves adding two expensive, non-shrinking/stiffening layers. Also, in focusing on reducing shrinkage of the melamine layer, the patentee ignores the finding of Epstein et al. that it is the higher fiber containing phenolic portion of the laminate which is the greater contributor to humidity related modifications.

Recognizing both the inevitability of wood pulp fibers to obey the laws of nature and the loss of economics in additional processing and/or material costs to create a wood fiber-based laminate that is impervious to the environment, the present invention involves preparing a dimensionally stable laminate by layering resin saturable sheets, treating the layered sheets with a polymeric resin, pressing the treated layered sheets together under high pressure and high temperature to form the laminate and then subjecting the newly manufactured laminate to high humidity (greater than 65%) at relatively low temperature (321-45° C.) for a period of greater than 24 hours (at atmospheric pressure) before exposure to ambient conditions. Exposure of industrial laminate samples to repetitive, extreme humidity cycles has shown that the laminate shrinkage observed, in both the machine direction (MD) and the cross direction (CD), is permanent and results primarily from the high humidity exposure. The non-linear expansion with respect to water absorbed in the laminates during their first exposure to high humidity is not observed again during subsequent humidity cycling. Evidence of this result is provided in the following example.

### EXAMPLE

This example study was conducted to determine the dimensional change versus water absorption relationship over repetitive humidity exposures and to determine if the laminate shrinkage that can be induced by extreme humidity exposures can be beneficial in improving the subsequent dimensional stability behavior of laminates. The laminates tested were laboratory-produced industrial laminates without a decorative sheet. Laminates produced from two different saturating papers were tested: 92# (per 3,000 ft²) and 137# (per 3,000 ft²). The 92# grade has been used extensively in commercial application and the 137# has shown good overall dimensional stability in comparison screenings of commercial papers.

Two laminates were tested from each-grade with commercial paper. The production procedure for these laminates is described in the Experimental section. Two versions of the 92# and 137# laminates were tested. One version consisted of laminate samples that were freshly pressed, and the second version consisted of laminate samples that had been stored in a laboratory, at ambient conditions, for a month or more. The freshly-pressed samples were labeled “New” and the month-old samples were labeled “Old.” The reason for separating the laminates in this manner was to determine if the dimensional change of the freshly-pressed laminates was different than that of the older laminates. The four laminates used in this study are, therefore, referred to as 92# (New), 92# (Old), 137# (New), and 137# (Old). Each laminate (eight total) was cut into six CD strips and six MD strips according to the specifications of the NEMA LD 3-1985 test for dimensional stability.

The laminates were divided into two identical sets. After initially conditioning the laminate samples of both sets at 50% relative humidity (RH), Set 1 was exposed to high humidity first and Set 2 was exposed to low humidity first. One cycle of Set 1 consisted of the following conditions: 50% RH, 74% RH, 98% RH, 74% RH, 50% RH, 2% RH, and 50% RH; and one cycle of Set 2 consisted of: 50% RH, 2% RH, 50% RH, 74% RH, 98% RH, 74% RH, and 50% RH. Set 2 laminates were introduced into the experiment after Set 1 had undergone its initial, high humidity portion of the cycle.

Set 1 laminates were subjected to two and one-half humidity cycles. In general, the laminates were held at the two high humidity conditions (74% and 98% RH) for two days, but they were held for four days at the 50% RH and 2% RH condition. This procedure was employed because water desorption in paper and laminates is generally slower than water absorption and also because of the lack of an intermediate, low-humidity condition. In view of the freshly manufactured status of the laminates, it is assumed that the primary benefit of high humidity exposure is gained within the first 24 hours of exposure under the atmospheric pressure condition of the experiment, although an exposure period of greater than 48 hours is preferred. It is recognized, however, that the exposure time period can be affected by various factors and, as a result, is not seen as a limitation to the invention. Such factors as the dimensions of the laminates themselves, whether they are stacked or individually separated during high humidity exposure, whether the exposure occurs under atmospheric or superatmospheric conditions, and other treatment conditions will allow variation of the required time of exposure, which is appreciated by those skilled in the art and which may be varied without departing from the spirit of that which is considered the subject matter of the invention.

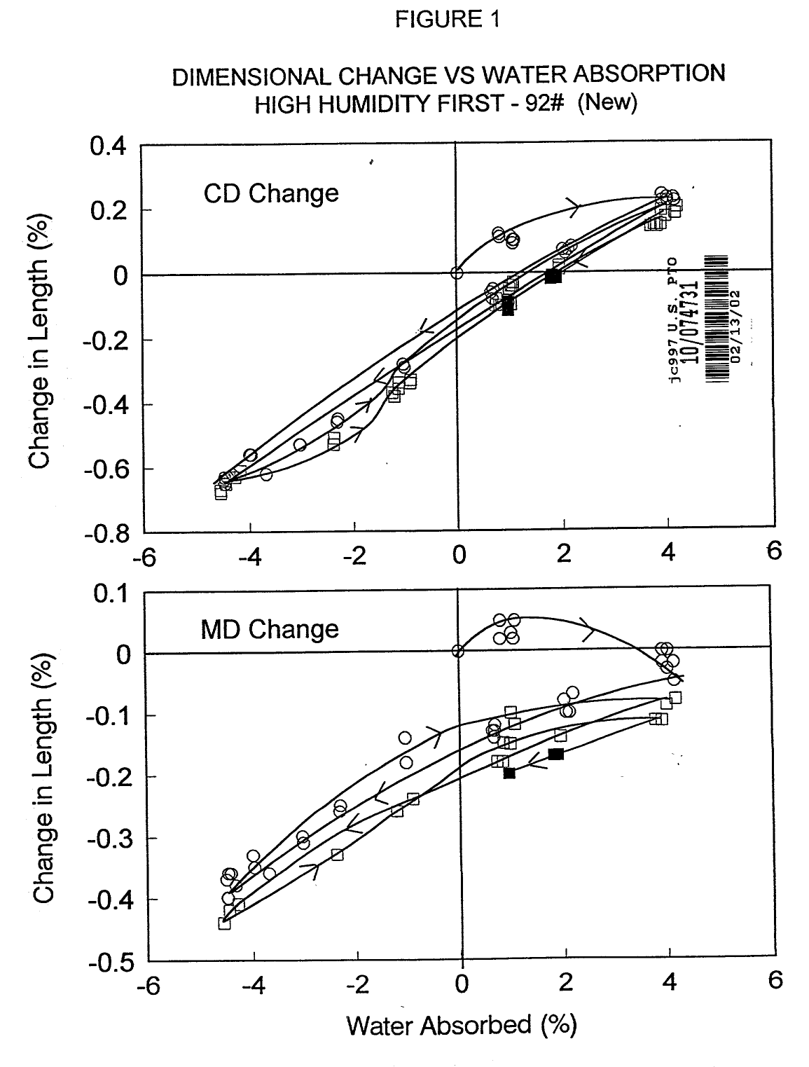

The results of the study is shown in FIGS. 1 through 9 and Tables I through IX, which show the estimated laminate dimensions after extreme humidity exposures.

### Results for Set 1 Laminates Exposed to High Humidity First

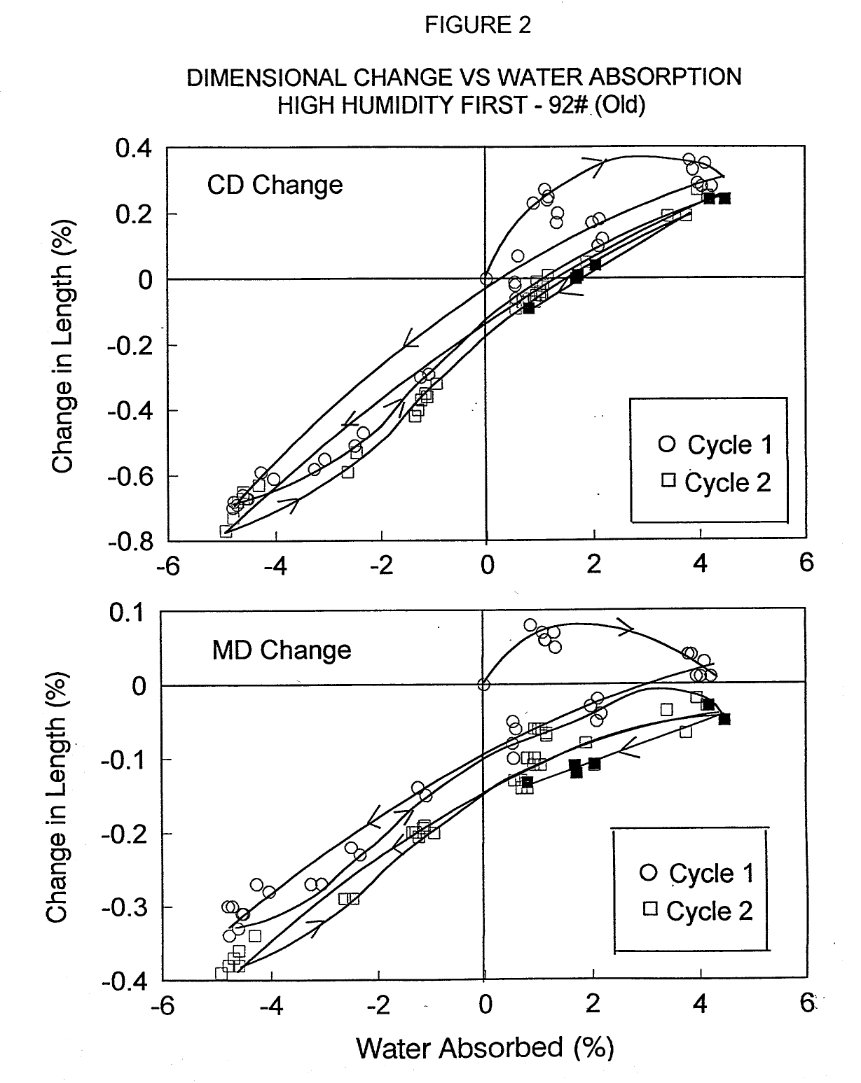

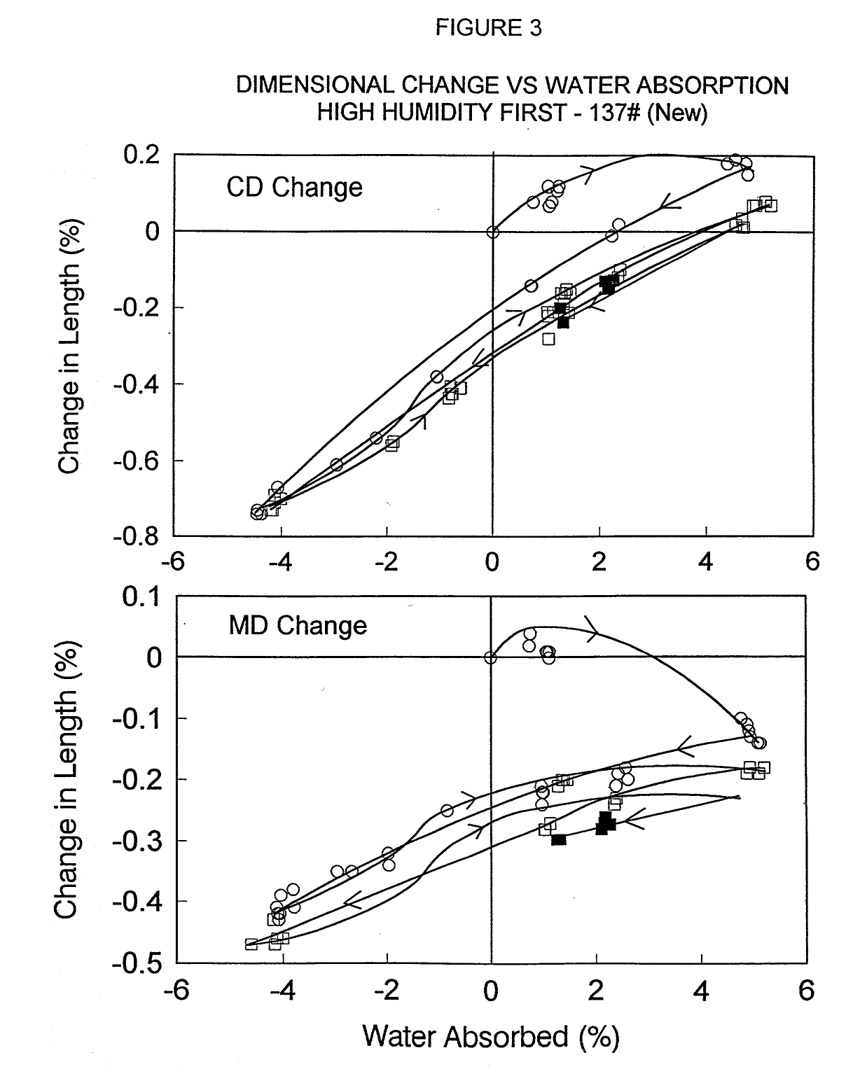

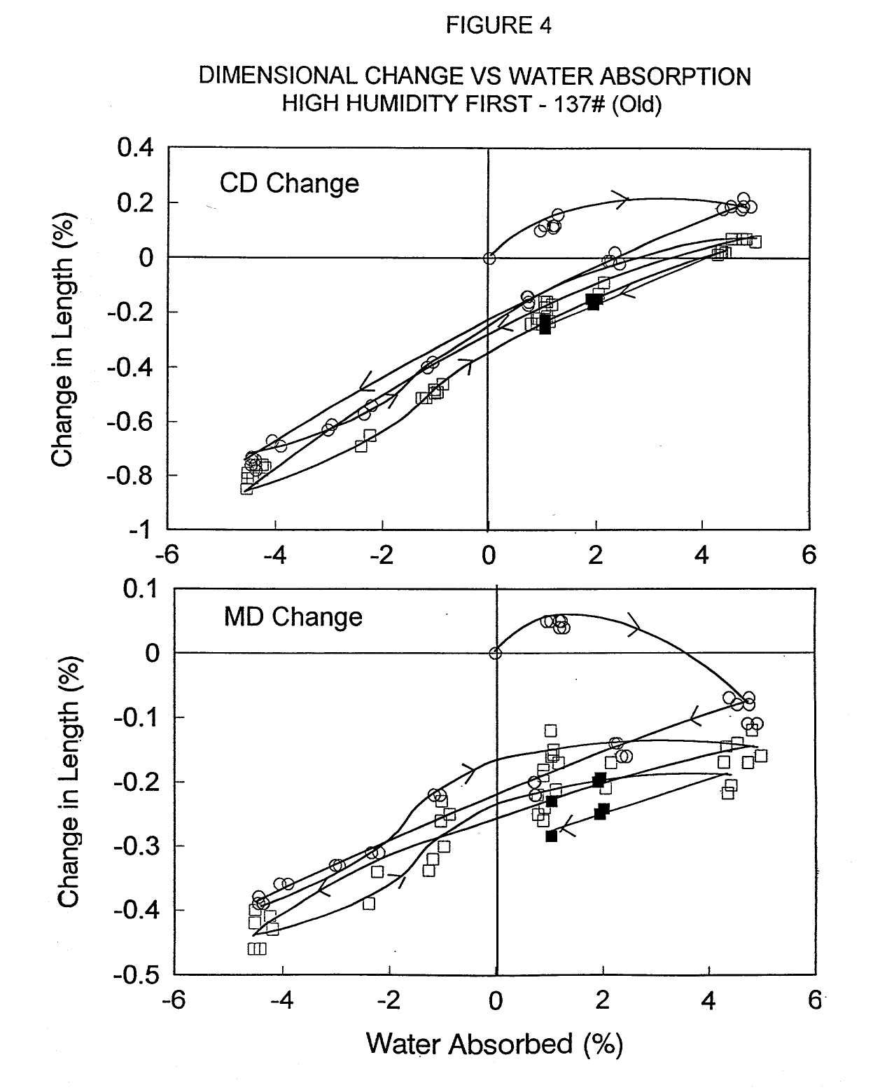

The changes in dimensional stability and water absorption that result from humidity cycling are graphically presented in a visually effective method where the dimensional change of the laminates in the CD and MD is graphed versus the change in mass of the laminates (percent of water absorbed/desorbed). FIGS. 1 through 4 are graphs of the CD and MD dimensional changes for the Set 1 laminates that underwent high humidity exposure first (data, respectively, from Tables I-IV). FIG. 1 for 92# (New), FIG. 2 for 92# (Old), FIG. 3 for 137# (New), and FIG. 4 for 137# (Old) have a similar appearance. The laminates expand in both the CD and MD when first exposed to high humidity. While this expansion levels off in the CD, the expansion actually changes into a contraction in the MD. After the expansion-contraction that occurs at high humidity, an almost linear relationship (slightly bow-shaped) is observed between all subsequent contractions, as humidity is lowered, and expansions as humidity is raised.

The laminate shrinkage is readily apparent in FIGS. 1-4, especially in the MD. As the laminates pass through the 50% RH condition (approaching from either direction) and return to the same mass that they had at the beginning of the study, the laminates do not return to their original dimensions but acquire smaller dimensions than they had before their original high humidity exposure. This phenomenon supports the concept that the initial laminate dimensions may be altered (laminates shrunken) by a high humidity conditioning process and that this shrunken laminate state can become the new starting dimensions of a laminate. Referring to FIGS. 1-4 (high humidity first), the maximum dimension (i e., greatest expansion) generally, but repeatedly, occurs at about 65% RH, which is considered the high humidity limitation of the invention. A preferred high humidity is greater than 75%, and a most preferred high humidity is greater than 90%.

The expansion-contraction curve seen in the dimensional stability graphs during the initial high humidity exposure is more pronounced for all the graphs in the MD than in the CD. This expansion, followed by contraction at high humidity, can possibly be attributed to the release of stresses that were built into the paper, and thereby the laminate, during the drying process. More stresses would be released in the MD than the CD since the paper is more restrained in this direction during the drying process. The MD curve appears to be more pronounced in the 137# grade than in the 92# grade. This result is consistent with the finding that the 137# grade had the lowest gross dimensional change (MD and CD) of the two dozen grades tested during initial screenings of commercial papers. The MD curve also appears to be more pronounced for the laminates labeled “New” versus the corresponding “Old” laminates. This is consistent with the concept that the curve results due to the release of drying stresses in the paper and that “Old” laminates have already undergone some of this stress-release, whereas “New” laminates have not.

In summary, the patterns that can be detected from studying FIGS. 1-4 depicting the average dimensional change of laminates exposed to high humidity first are:

1. In the CD, laminates expand during initial high humidity exposure, and then the expansion levels off (i.e., subsequent changes in the CD dimensions are reduced by at least 30% (preferably 40% and, most preferably, at least 50%) of the changes due to the initial high humidity exposure);

2. In the MD, laminates expand during the initial high humidity exposure and then contract (i.e., subsequent changes in the MD dimensions are reduced by at least 30% (preferably 40% and, most preferably, at least 50%) of the changes due to the initial high humidity exposure);

3. After the initial expansion-contraction behavior noted above, laminates expand and contract in an almost linear manner (bow-shaped) through subsequent low and high humidity exposures;

4. The initial expansion-contraction behavior noted above in the MD is more pronounced in the 137# grades than in the 92# grades, indicating more MD laminate contraction at high humidity; and

5. The initial expansion-contraction behavior noted above in the MD is slightly more pronounced in “New” laminates versus the corresponding “Old” laminates, indicating that more dryer-induced stresses may be relieved during the high humidity exposure of “New” laminates versus that of “Old” laminates.

The following Tables I-VIII present, in tabular form, the experimental data depicted in graphical form, respectively, in FIGS. 1-8.

TABLE I
Cyclic Humidity Data for Set 1 - High Humidity First
Grade 92# (New)

| | | | Change in Dimensions from Initial (%) | | | | | | | |
|---|---|---|---|---|---|---|---|---|---|---|
| | | Elapsed | Laminate 1 | | | | Laminate 2 | | | |
| Condition | Time | Time (hr) | MD | CD | Mass | Thick | MD | CD | Mass | Thick |
| Start @ | 3-24-95 to | 0 | 0 | 0 | 0 | 0 | 0 | 0 | 0 | 0 |
| 50% RH, 22 C. | 3-27-95 10:00 AM | | | | | | | | | |
| Switch to | 3-27-95 5:00 PM | 7 | 0.05 | 0.11 | 0.81 | 1.85 | 0.02 | 0.12 | 0.80 | 1.39 |
| 74% RH, 38 C. | 3-28-95 8:15 AM | 22 | 0.03 | 0.11 | 1.02 | 1.86 | 0.02 | 0.09 | 1.06 | 2.03 |
| | 3-29-95 8:15 AM | 46 | 0.02 | 0.10 | 1.06 | 1.57 | 0.05 | 0.10 | 1.09 | 1.02 |
| Switch to | 3-30-95 8:30 AM | 70 | −0.02 | 0.24 | 3.92 | 6.02 | 0.00 | 0.22 | 3.92 | 5.72 |
| 98% RH, 38 C. | 3-31-95 8:30 AM | 94 | −0.03 | 0.23 | 4.01 | 5.73 | 0.00 | 0.22 | 4.02 | 5.63 |
| | 4-3-95 8:30 AM | 166 | −0.05 | 0.22 | 4.15 | 5.83 | −0.02 | 0.23 | 4.13 | 5.54 |
| Switch to | 4-4-95 8:30 AM | 190 | −0.10 | 0.07 | 2.12 | 3.61 | −0.07 | 0.08 | 2.19 | 3.50 |
| 74% RH, 38 C. | 4-5-95 8:30 AM | 214 | −0.10 | 0.06 | 2.06 | 3.15 | −0.08 | 0.07 | 2.02 | 3.23 |
| Switch to | 4-6-95 8:30 AM | 238 | −0.14 | −0.08 | 0.67 | 1.57 | −0.12 | −0.05 | 0.69 | 1.57 |
| 50% RH, 22 C. | 4-7-95 1:30 PM | 267 | −0.13 | −0.06 | 0.64 | 1.95 | −0.13 | −0.05 | 0.68 | 1.85 |
| Switch to | 4-8-95 8:40 AM | 286 | −0.33 | −0.56 | −4.00 | −1.85 | −0.35 | −0.56 | −3.97 | −2.21 |
| 2% RH, 70 C. | 4-9-95 1:00 PM | 314 | −0.36 | −0.63 | −4.42 | −2.13 | −0.38 | −0.62 | −4.33 | −2.67 |
| | 4-10-95 9:30 AM | 334 | −0.37 | −0.64 | −4.50 | −2.41 | −0.36 | −0.62 | −3.69 | −2.40 |
| | 4-11-95 9:15 AM | 358 | −0.40 | −0.63 | −4.48 | −2.69 | −0.36 | −0.65 | −4.47 | −2.86 |
| Switch to | 4-12-95 8:15 AM | 381 | −0.31 | −0.53 | −3.02 | −1.86 | −0.30 | −0.53 | −3.03 | −2.12 |
| 50% RH, 22 C. | 4-13-95 8:15 AM | 405 | −0.25 | −0.45 | −2.30 | −1.76 | −0.26 | −0.46 | −2.31 | −1.48 |
| | 4-17-95 8:15 AM | 501 | −0.18 | −0.29 | −1.02 | −0.75 | −0.14 | −0.28 | −1.04 | −0.65 |
| Switch to | 4-18-95 8:30 AM | 525 | −0.10 | −0.05 | 1.00 | 1.85 | −0.08 | −0.04 | 1.03 | 1.66 |
| 74% RH, 38 C. | 4-19-95 8:15 AM | 549 | −0.12 | −0.03 | 1.07 | 1.85 | −0.11 | −0.04 | 1.06 | 1.57 |
| Switch to | 4-20-95 8:30 AM | 573 | −0.09 | 0.17 | 3.99 | 5.55 | −0.07 | 0.19 | 3.91 | 5.81 |
| 98% RH, 38 C. | 4-21-95 8:15 AM | 597 | −0.08 | 0.18 | 4.17 | 5.73 | −0.07 | 0.20 | 4.20 | 5.90 |
| Switch to | 4-24-95 8:30 AM | 621 | −0.14 | 0.02 | 1.95 | 2.96 | −0.13 | 0.01 | 1.95 | 3.13 |
| 74% RH, 38 C. | | | | | | | | | | |
| Switch to | 4-25-95 8:30 AM | 645 | −0.18 | −0.10 | 0.73 | 1.66 | −0.16 | −0.06 | 0.74 | 1.57 |
| 50% RH, 22 C. | 4-26-95 8:30 AM | 669 | −0.18 | −0.10 | 0.84 | 1.57 | −0.15 | −0.10 | 0.84 | 1.48 |
| Switch to | 4-27-95 9:30 AM | 694 | −0.41 | −0.63 | −4.28 | −2.59 | −0.39 | −0.61 | −4.18 | −3.04 |
| 2% RH, 70 C. | 4-28-95 10:00 AM | 719 | −0.42 | −0.65 | −4.45 | −2.87 | −0.42 | −0.64 | −4.48 | −2.95 |
| | 4-30-95 4:00 PM | 773 | −0.44 | −0.67 | −4.56 | −2.87 | −0.40 | −0.68 | −4.55 | −3.23 |
| Switch to | 5-01-95 8:30 AM | 789 | −0.33 | −0.51 | −2.37 | −1.21 | −0.31 | −0.53 | −2.38 | −1.20 |
| 50% RH, 22 C. | 5-02-95 8:15 AM | 813 | −0.26 | −0.38 | −1.21 | −1.02 | −0.25 | −0.37 | −1.25 | −0.92 |
| | 5-03-95 8:15 AM | 837 | −0.43 | −0.34 | −1.12 | −0.56 | −0.23 | −0.36 | −1.13 | −0.73 |
| | 5-04-95 8:30 AM | 861 | −0.24 | −0.33 | −0.90 | −0.56 | −0.21 | −0.34 | −0.91 | −0.55 |
| Switch to | 5-05-95 8:15 AM | 885 | −0.15 | −0.10 | 0.85 | 1.29 | −0.14 | −0.10 | 0.81 | 1.57 |
| 74% RH, 38 C. | 5-08-95 8:30 AM | 957 | −0.15 | −0.08 | 0.98 | 1.48 | −0.15 | −0.10 | 1.03 | 1.20 |
| Switch to | 5-09-95 8:30 AM | 981 | −0.11 | 0.15 | 3.78 | 4.90 | −0.09 | 0.14 | 3.71 | 4.98 |
| 98% RH, 38 C. | 5-10-95 8:15 AM | 1005 | −0.11 | 0.15 | 3.90 | 5.36 | −0.09 | 0.14 | 3.82 | 5.26 |
| Switch to | 5-11-95 8:30 AM | 1029 | −0.17 | −0.01 | 1.90 | 3.05 | −0.16 | −0.02 | 1.90 | 2.76 |
| 74% RH, 38 C. | 5-12-95 8:15 AM | 1053 | −0.17 | −0.01 | 1.82 | 2.59 | −0.16 | −0.02 | 1.79 | 2.31 |
| Switch to | 5-15-95 8:30 AM | 1125 | −0.20 | −0.09 | 0.96 | 1.94 | −0.18 | −0.12 | 0.97 | 1.66 |
| 50% RH, 22 C. | | | | | | | | | | |

TABLE II
Cyclic Humidity Data for Set 1 - High Humidity First
Grade 92# (Old)

| | | | Change in Dimensions from Initial (%) | | | | | | | |
|---|---|---|---|---|---|---|---|---|---|---|
| | | Elapsed | Laminate 1 | | | | Laminate 2 | | | |
| Condition | Time | Time (hr) | MD | CD | Mass | Thick | MD | CD | Mass | Thick |
| Start @ | 3-24-95 10:00 AM | 0 | 0 | 0 | 0 | 0 | 0 | 0 | 0 | 0 |
| 50% RH, 22 C. | 3-27-95 10:00 AM | | | | | | | | | |
| Switch to | 3-27-95 5:00 PM | 7 | 0.08 | 0.23 | 0.88 | 1.01 | 0.07 | 0.27 | 1.10 | 1.37 |
| 74% RH, 38 C. | 3-28-95 8:15 AM | 22 | 0.06 | 0.15 | 1.16 | 1.47 | 0.07 | 0.17 | 1.32 | 1.29 |
| | 3-29-95 8:15 AM | 46 | 0.06 | 0.14 | 1.14 | 2.13 | 0.05 | 0.20 | 1.34 | 0.92 |
| Switch to | 3-30-95 8:30 AM | 70 | 0.01 | 0.29 | 3.96 | 4.23 | 0.04 | 0.36 | 3.80 | 4.12 |
| 98% RH, 38 C. | 3-31-95 8:30 AM | 94 | 0.01 | 0.28 | 4.04 | 4.42 | 0.04 | 0.33 | 3.87 | 3.85 |
| | 4-3-95 8:30 AM | 166 | 0.01 | 0.28 | 4.23 | 4.42 | 0.03 | 0.35 | 4.11 | 4.30 |
| Switch to | 4-4-95 8:30 AM | 190 | −0.04 | 0.12 | 2.18 | 2.58 | −0.02 | 0.18 | 2.12 | 2.11 |
| 74% RH, 38 C. | 4-5-95 8:30 AM | 214 | −0.05 | 0.10 | 2.10 | 2.39 | −0.03 | 0.17 | 1.99 | 1.93 |
| Switch to | 4-6-95 8:30 AM | 238 | −0.10 | −0.06 | 0.55 | 0.65 | −0.08 | −0.01 | 0.53 | 0.28 |
| 50% RH, 22 C. | 4-7-95 1:30 PM | 267 | −0.06 | 0.07 | 0.59 | 1.38 | −0.05 | −0.02 | 0.54 | 0.91 |
| Switch to | 4-8-95 8:40 AM | 286 | −0.28 | −0.61 | −4.04 | −2.30 | −0.27 | −0.59 | −4.27 | −2.38 |
| 2% RH, 70 C. | 4-9-95 1:00 PM | 314 | −0.31 | −0.67 | −4.54 | −2.76 | −0.30 | −0.69 | −4.72 | −3.11 |
| | 4-10-95 9:30 AM | 334 | −0.31 | −0.67 | −4.51 | −3.77 | −0.30 | −0.70 | −4.80 | −3.39 |
| | 4-11-95 9:15 AM | 358 | −0.33 | −0.66 | −4.61 | −3.22 | −0.34 | −0.68 | −4.78 | −3.57 |
| Switch to | 4-12-95 8:15 AM | 381 | −0.27 | −0.55 | −3.06 | −2.67 | −0.27 | −0.58 | −3.26 | −2.56 |
| 50% RH, 22 C. | 4-13-95 8:15 AM | 405 | −0.23 | −0.47 | −2.34 | −2.76 | −0.22 | −0.51 | −2.50 | −2.38 |
| | 4-17-95 8:15 AM | 501 | −0.15 | −0.29 | −1.10 | −1.47 | −0.14 | −0.30 | −1.25 | −1.56 |
| Switch to | 4-18-95 8:30 AM | 525 | −0.06 | −0.05 | 1.01 | 1.01 | −0.06 | −0.01 | 0.94 | 0.46 |
| 74% RH, 38 C. | 4-19-95 8:15 AM | 549 | −0.07 | 0.01 | 1.16 | 0.65 | −0.06 | −0.02 | 1.07 | 0.64 |
| Switch to | 4-20-95 8:30 AM | 573 | −0.03 | 0.24 | 4.19 | 4.89 | −0.02 | 0.27 | 3.96 | 4.12 |
| 98% RH, 38 C. | 4-21-95 8:15 AM | 597 | −0.05 | 0.24 | 4.48 | 5.44 | −0.03 | 0.25 | 4.15 | 4.39 |
| Switch to | 4-24-95 8:30 AM | 621 | −0.11 | 0.04 | 2.05 | 2.73 | −0.08 | 0.05 | 1.89 | 1.65 |
| 74% RH, 38 C. | | | | | | | | | | |
| Switch to | 4-25-95 8:30 AM | 645 | −0.14 | −0.07 | 0.69 | 0.92 | −0.13 | −0.09 | 0.55 | 0.46 |
| 50% RH, 22 C. | 4-26-95 8:30 AM | 669 | −0.14 | −0.06 | 0.80 | 1.35 | −0.13 | −0.07 | 0.68 | 0.55 |
| Switch to | 4-27-95 9:30 AM | 694 | −0.34 | −0.63 | −4.31 | −3.43 | −0.36 | −0.67 | −4.60 | −3.47 |
| 2% RH, 70 C. | 4-28-95 10:00 AM | 719 | −0.38 | −0.65 | −4.60 | −3.58 | −0.38 | −0.73 | −4.79 | −3.75 |
| | 4-30-95 4:00 PM | 773 | −0.37 | −0.68 | −4.70 | −3.61 | −0.39 | −0.77 | −4.93 | −3.75 |
| Switch to | 5-01-95 8:30 AM | 789 | −0.29 | −0.53 | −2.47 | −2.12 | −0.29 | −0.59 | −2.63 | −2.01 |
| 50% RH, 22 C. | 5-02-95 8:15 AM | 813 | −0.21 | −0.37 | −1.24 | −1.87 | −0.20 | −0.42 | −1.36 | −1.55 |
| | 5-03-95 8:15 AM | 837 | −0.19 | −0.35 | −1.16 | −1.31 | −0.20 | −0.40 | −1.30 | −0.82 |
| | 5-04-95 8:30 AM | 861 | −0.20 | −0.32 | −0.95 | −1.22 | −0.19 | −0.36 | −1.13 | −1.46 |
| Switch to | 5-05-95 8:15 AM | 885 | −0.10 | −0.05 | 0.94 | 1.17 | −0.10 | −0.07 | 0.80 | 0.64 |
| 74% RH, 38 C. | 5-08-95 8:30 AM | 957 | −0.11 | −0.05 | 1.05 | 1.17 | −0.11 | −0.07 | 0.91 | 0.92 |
| Switch to | 5-09-95 8:30 AM | 981 | −0.06 | −0.05 | 1.01 | 1.01 | −0.04 | 0.19 | 3.40 | 3.93 |
| 98% RH, 38 C. | 5-10-95 8:15 AM | 1005 | −0.07 | 0.01 | 1.16 | 0.65 | −0.07 | 0.19 | 3.75 | 3.93 |
| Switch to | 5-11-95 8:30 AM | 1029 | −0.03 | 0.24 | 4.19 | 4.89 | −0.12 | 0.01 | 1.72 | 1.92 |
| 74% RH, 38 C. | 5-12-95 8:15 AM | 1053 | −0.05 | 0.24 | 4.48 | 5.44 | −0.11 | 0.00 | 1.69 | 1.74 |
| Switch to | 5-15-95 8:30 AM | 1125 | −0.11 | 0.04 | 2.05 | 2.73 | −0.13 | −0.09 | 0.80 | 0.73 |
| 50% RH, 22 C. | | | | | | | | | | |

TABLE III
Cyclic Humidity Data for Set 1 - High Humidity First
Grade 137# (New)

| | | | Change in Dimensions from Initial (%) | | | | | | | |
|---|---|---|---|---|---|---|---|---|---|---|
| | | Elapsed | Laminate 1 | | | | Laminate 2 | | | |
| Condition | Time | Time (hr) | MD | CD | Mass | Thick | MD | CD | Mass | Thick |
| Start @ | 3-24-95 to | 0 | 0 | 0 | 0 | 0 | 0 | 0 | 0 | 0 |
| 50% RH, 22 C. | 3-27-95 10:00 AM | | | | | | | | | |
| Switch to | 3-27-95 5:00 PM | 7 | 0.04 | 0.08 | 0.75 | 1.58 | 0.02 | 0.09 | 0.73 | 1.78 |
| 74% RH, 38 C. | 3-28-95 8:15 AM | 22 | 0.00 | 0.08 | 1.10 | 1.31 | 0.01 | O.06 | 1.11 | 1.78 |
| | 3-29-95 8:15 AM | 46 | 0.01 | 0.07 | 1.05 | 1.41 | 0.01 | 0.07 | 1.07 | 1.78 |
| Switch to | 3-30-95 8:30 AM | 70 | −0.10 | 0.15 | 4.76 | 7.00 | −0.12 | 0.14 | 4.90 | 7.59 |
| 98% RH, 38 C. | 3-31-95 8:30 AM | 94 | −0.13 | 0.15 | 4.93 | 6.72 | −0.11 | 0.12 | 4.87 | 6.94 |
| | 4-3-95 8:30 AM | 166 | −0.14 | 0.15 | 5.12 | 6.90 | −0.14 | 0.11 | 5.08 | 7.22 |
| Switch to | 4-4-95 8:30 AM | 190 | −0.18 | −0.04 | 2.55 | 4.20 | −0.20 | −0.06 | 2.60 | 4.50 |
| 74% RH, 38 C. | 4-5-95 8:30 AM | 214 | −0.19 | −0.04 | 2.41 | 3.83 | −0.21 | −0.05 | 2.37 | 4.13 |
| Switch to | 4-6-95 8:30 AM | 238 | −0.22 | −0.16 | 0.98 | 2.33 | −0.22 | −0.16 | 1.00 | 2.52 |
| 50% RH, 22 C. | 4-7-95 1:30 PM | 267 | −0.21 | −0.17 | 0.96 | 2.34 | −0.24 | −0.16 | 0.97 | 3.09 |
| Switch to | 4-8-95 8:40 AM | 286 | −0.38 | −0.64 | −3.82 | −1.77 | −0.41 | −0.61 | −3.80 | −1.12 |
| 2% RH, 70 C. | 4-9-95 1:00 PM | 314 | −0.39 | −0.69 | −4.05 | −1.96 | −0.43 | −0.67 | −4.09 | −1.03 |
| | 4-10-95 9:30 AM | 334 | −0.41 | −0.70 | −4.13 | −2.14 | −0.43 | −0.67 | −4.09 | −1.21 |
| | 4-11-95 9:15 AM | 358 | −0.42 | −0.67 | −4.11 | −2.33 | −0.42 | −0.69 | −4.07 | −1.87 |
| Switch to | 4-12-95 8:15 AM | 381 | −0.35 | −0.55 | −2.69 | −1.32 | −0.35 | −0.58 | −2.68 | −1.13 |
| 50% RH, 22 C. | 4-13-95 8:15 AM | 405 | −0.32 | −0.48 | −1.98 | −0.84 | −0.34 | −0.50 | −1.97 | −0.47 |
| | 4-17-95 8:15 AM | 501 | −0.25 | −0.36 | −0.84 | −0.10 | −0.25 | −0.35 | −0.84 | 0.38 |
| Switch to | 4-18-95 8:30 AM | 525 | −0.21 | −0.16 | 1.28 | 2.33 | −0.20 | −0.16 | 1.35 | 2.72 |
| 74% RH, 38 C. | 4-19-95 8:15 AM | 549 | −0.20 | −0.15 | 1.38 | 2.43 | −0.20 | −0.16 | 1.45 | 2.63 |
| Switch to | 4-20-95 8:30 AM | 573 | −0.19 | 0.07 | 4.86 | 7.19 | −0.18 | 0.07 | 4.92 | 7.88 |
| 98% RH, 38 C. | 4-21-95 8:15 AM | 597 | −0.19 | 0.08 | 5.10 | 7.27 | −0.18 | 0.07 | 5.20 | 7.50 |
| Switch to | 4-24-95 8:30 AM | 621 | −0.23 | −0.10 | 2.38 | 4.20 | −0.24 | −0.12 | 2.34 | 4.12 |
| 74% RH, 38 C. | | | | | | | | | | |
| Switch to | 4-25-95 8:30 AM | 645 | −0.28 | −0.21 | 1.02 | 2.43 | −0.28 | −0.22 | 1.03 | 2.82 |
| 50% RH, 22 C. | 4-26-95 8:30 AM | 669 | −0.27 | −0.21 | 1.13 | 2.24 | −0.27 | −0.21 | 1.13 | 2.72 |
| Switch to | 4-27-95 9:30 AM | 694 | −0.46 | −0.70 | −4.01 | −2.14 | −0.47 | −0.54 | −4.61 | −3.44 |
| 2% RH, 70 C. | 4-28-95 10:00 AM | 719 | −0.46 | −0.71 | −4.12 | −2.05 | −0.46 | −0.69 | −4.12 | −1.97 |
| | 4-30-95 4:00 PM | 773 | −0.43 | −0.73 | −4.19 | −2.24 | −0.47 | −0.73 | −4.16 | −1.77 |
| Switch to | 5-01-95 8:30 AM | 789 | −0.39 | −0.56 | −1.91 | −0.19 | −0.41 | −0.55 | −1.87 | 0.28 |
| 50% RH, 22 C. | 5-02-95 8:15 AM | 813 | −0.32 | −0.44 | −0.82 | 0.00 | −0.33 | −0.42 | −0.77 | 0.75 |
| | 5-03-95 8:15 AM | 837 | −0.31 | −0.41 | −0.79 | 0.19 | −0.33 | −0.42 | −0.75 | 0.84 |
| | 5-04-95 8:30 AM | 861 | −0.31 | −0.41 | −0.61 | 0.09 | −0.30 | −0.41 | −0.59 | 0.66 |
| Switch to | 5-05-95 8:15 AM | 885 | −0.24 | −0.28 | 1.05 | 1.87 | −0.22 | −0.21 | 1.33 | 2.34 |
| 74% RH, 38 C. | 5-08-95 8:30 AM | 957 | −0.25 | −0.19 | 1.33 | 2.33 | −0.24 | −0.21 | 1.43 | 2.90 |
| Switch to | 5-09-95 8:30 AM | 981 | −0.23 | 0.02 | 4.54 | 6.16 | −0.22 | 0.01 | 4.66 | 6.74 |
| 98% RH, 38 C. | 5-10-95 8:15 AM | 1005 | −0.22 | 0.04 | 4.66 | 6.62 | −0.24 | 0.01 | 4.69 | 6.65 |
| Switch to | 5-11-95 8:30 AM | 1029 | −0.27 | −0.13 | 2.26 | 3.46 | −0.26 | −0.15 | 2.17 | 4.03 |
| 74% RH, 38 C. | 5-12-95 8:15 AM | 1053 | −0.28 | −0.13 | 2.10 | 3.74 | −0.27 | −0.15 | 2.15 | 4.03 |
| Switch to | 5-15-95 8:30 AM | 1125 | −0.30 | −0.20 | 1.26 | 2.52 | −0.30 | −0.24 | 1.32 | 2.63 |
| 50% RH, 22 C. | | | | | | | | | | |

TABLE IV
Cyclic Humidity Data for Set 1 - High Humidity First
Grade 137# (Old)

| | | | Change in Dimensions from Initial (%) | | | | | | | |
|---|---|---|---|---|---|---|---|---|---|---|
| | | Elapsed | Laminate 1 | | | | Laminate 2 | | | |
| Condition | Time | Time (hr) | MD | CD | Mass | Thick | MD | CD | Mass | Thick |
| Start @ | 3-24-95 10:00 AM | 0 | 0 | 0 | 0 | 0 | 0 | 0 | 0 | 0 |
| 50% RH, 22 C. | 3-27-95 10:00 AM | | | | | | | | | |
| Switch to | 3-27-95 5:00 PM | 7 | 0.05 | 0.10 | 0.95 | 1.56 | 0.04 | 0.12 | 1.03 | 1.62 |
| 74% RH, 38 C. | 3-28-95 8:15 AM | 22 | 0.05 | 0.12 | 1.19 | 1.26 | 0.05 | 0.12 | 1.23 | 1.53 |
| | 3-29-95 8:15 AM | 46 | 0.04 | 0.16 | 1.28 | 1.85 | 0.04 | 0.11 | 1.20 | 1.24 |
| Switch to | 3-30-95 8:30 AM | 70 | −0.07 | 0.22 | 4.76 | 6.61 | −0.02 | 0.18 | 4.38 | 6.11 |
| 98% RH, 38 C. | 3-31-95 8:30 AM | 94 | −0.08 | 0.19 | 4.76 | 5.83 | −0.05 | 0.19 | 4.53 | 5.81 |
| | 4-3-95 8:30 AM | 166 | −0.11 | 0.19 | 4.91 | 6.22 | −0.05 | 0.18 | 4.73 | 6.30 |
| Switch to | 4-4-95 8:30 AM | 190 | −0.16 | −0.02 | 2.44 | 3.59 | −0.10 | 0.02 | 2.35 | 3.72 |
| 74% RH, 38 C. | 4-5-95 8:30 AM | 214 | −0.14 | −0.01 | 2.27 | 3.50 | −0.10 | −0.01 | 2.22 | 3.72 |
| Switch to | 4-6-95 8:30 AM | 238 | −0.22 | −0.16 | 0.74 | 1.75 | −0.15 | −0.14 | 0.73 | 1.82 |
| 50% RH, 22 C. | 4-7-95 1:30 PM | 267 | −0.20 | −0.17 | 0.73 | 1.85 | −0.17 | −0.14 | 0.71 | 2.01 |
| Switch to | 4-8-95 8:40 AM | 286 | −0.36 | −0.69 | −3.90 | −1.65 | −0.34 | −0.67 | −4.06 | −2.10 |
| 2% RH, 70 C. | 4-9-95 1:00 PM | 314 | −0.39 | −0.78 | −4.36 | −2.43 | −0.35 | −0.74 | −4.37 | −2.39 |
| | 4-10-95 9:30 AM | 334 | −0.39 | −0.76 | −4.37 | −2.52 | −0.36 | −0.74 | −4.45 | −2.48 |
| | 4-11-95 9:15 AM | 358 | −0.38 | −0.76 | −4.45 | −3.01 | −0.34 | −0.73 | −4.44 | −2.58 |
| Switch to | 4-12-95 8:15 AM | 381 | −0.33 | −0.63 | −3.01 | −1.94 | −0.27 | −0.61 | −2.94 | −1.53 |
| 50% RH, 22 C. | 4-13-95 8:15 AM | 405 | −0.31 | −0.57 | −2.34 | −1.55 | −0.24 | −0.54 | −2.20 | −1.53 |
| | 4-17-95 8:15 AM | 501 | −0.22 | −0.40 | −1.16 | −0.68 | −0.17 | −0.38 | −1.05 | −0.48 |
| Switch to | 4-18-95 8:30 AM | 525 | −0.16 | −0.18 | 1.04 | 1.65 | −0.12 | −0.16 | 1.03 | 1.91 |
| 74% RH, 38 C. | 4-19-95 8:15 AM | 549 | −0.17 | −0.17 | 1.18 | 1.85 | −0.15 | −0.16 | 1.08 | 2.29 |
| Switch to | 4-20-95 8:30 AM | 573 | −0.17 | 0.07 | 4.74 | 6.12 | −0.14 | 0.07 | 4.54 | 6.20 |
| 98% RH, 38 C. | 4-21-95 8:15 AM | 597 | −0.16 | 0.06 | 4.99 | 6.70 | −0.12 | 0.07 | 4.82 | 6.49 |
| Switch to | 4-24-95 9:30 AM | 621 | −0.21 | −0.13 | 2.05 | 3.11 | −0.17 | −0.09 | 2.15 | 3.53 |
| 74% RH, 38 C. | | | | | | | | | | |
| Switch to | 4-25-95 8:30 AM | 645 | −0.25 | −0.24 | 0.79 | 1.95 | −0.22 | −0.24 | 0.78 | 2.00 |
| 50% RH, 22 C. | 4-26-95 8:30 AM | 669 | −0.26 | −0.22 | 0.89 | 1.85 | −0.19 | −0.24 | 0.89 | 1.91 |
| Switch to | 4-27-95 9:30 AM | 694 | −0.43 | −0.77 | −4.19 | −2.43 | −0.41 | −0.76 | −4.24 | −2.48 |
| 2% RH, 70 C. | 4-28-95 10:00 AM | 719 | −0.46 | −0.81 | −4.42 | −2.81 | −0.40 | −0.79 | −4.51 | −2.58 |
| | 4-30-95 4:00 PM | 773 | −0.46 | −0.85 | −4.53 | −2.52 | −0.42 | −0.81 | −4.52 | −2.48 |
| Switch to | 5-01-95 8:30 AM | 789 | −0.39 | −0.69 | −2.39 | −1.17 | −0.34 | −0.65 | −2.23 | −1.15 |
| 50% RH, 22 C. | 5-02-95 8:15 AM | 813 | −0.34 | −0.51 | −1.26 | −0.39 | −0.23 | −0.49 | −1.02 | −0.19 |
| | 5-03-95 8:15 AM | 837 | −0.32 | −0.51 | −1.18 | −0.58 | −0.26 | −0.48 | −1.03 | −0.29 |
| | 5-04-95 8:30 AM | 861 | −0.30 | −0.49 | −0.97 | −0.87 | −0.25 | −0.46 | −0.87 | −0.57 |
| Switch to | 5-05-95 8:15 AM | 885 | −0.24 | −0.22 | 0.92 | 1.75 | −0.18 | −0.22 | 0.89 | 1.81 |
| 74% RH, 38 C. | 5-08-95 8:30 AM | 957 | −0.21 | −0.23 | 1.13 | 2.24 | −0.16 | −0.21 | 1.08 | 1.81 |
| Switch to | 5-09-95 8:30 AM | 981 | −0.21 | 0.02 | 4.42 | 6.02 | −0.15 | 0.02 | 4.33 | 5.63 |
| 98% RH, 38 C. | 5-10-95 8:15 AM | 1005 | −0.22 | 0.02 | 4.36 | 5.93 | −0.17 | 0.01 | 4.28 | 5.82 |
| Switch to | 5-11-95 8:30 AM | 1029 | −0.24 | −0.15 | 2.02 | 3.21 | −0.19 | −0.15 | 1.96 | 3.24 |
| 74% RH, 38 C. | 5-12-95 8:15 AM | 1053 | −0.25 | −0.17 | 1.95 | 3.21 | −0.20 | −0.15 | 1.91 | 3.05 |
| Switch to | 5-15-95 8:30 AM | 1125 | −0.28 | −0.26 | 1.05 | 2.04 | −0.23 | −0.22 | 1.05 | 2.39 |
| 50% RH, 22 C. | | | | | | | | | | |

TABLE V
Cyclic Humidity Data for Set 2 - Low Humidity First
Grade 92# (New)

| | | | Change in Dimensions from Initial (%) | | | | | | | |
|---|---|---|---|---|---|---|---|---|---|---|
| | | Elapsed | Laminate 1 | | | | Laminate 2 | | | |
| Condition | Time | Time (hr) | MD | CD | Mass | Thick | MD | CD | Mass | Thick |
| Start @ | 4-3-95 | 0 | 0 | 0 | 0 | 0 | 0 | 0 | 0 | 0 |
| 50% RH, 22 C. | 4-7-95 1:30 PM | | | | | | | | | |
| Switch to | 4-8-95 9:45 AM | 47 | −0.22 | −0.46 | −3.70 | −2.33 | −0.22 | −0.45 | −3.71 | −1.85 |
| 2% RH, 70 C. | 4-9-95 2:10 PM | 76 | −0.23 | −0.51 | −4.11 | −2.70 | −0.27 | −0.49 | −4.11 | −2.87 |
| | 4-10-95 10:50 AM | 97 | −0.25 | −0.52 | −4.14 | −2.98 | −0.26 | −0.51 | −4.12 | −2.78 |
| | 4-11-95 10:30 AM | 121 | −0.25 | −0.54 | −4.15 | −3.17 | −0.23 | −0.51 | −4.15 | −2.50 |
| Switch to | 4-12-95 9:30 AM | 144 | −0.21 | −0.43 | −2.88 | −2.61 | −0.19 | −0.41 | −2.92 | −2.32 |
| 50% RH, 22 C. | 4-13-95 9:30 AM | 168 | −0.16 | −0.36 | −2.20 | −2.05 | −0.14 | −0.35 | −2.22 | −2.14 |
| | 4-17-95 9:45 AM | 264 | −0.08 | −0.19 | −0.87 | −0.93 | −0.07 | −0.16 | −0.90 | −0.65 |
| Switch to | 4-18-95 9:45 AM | 288 | 0.00 | 0.07 | 1.05 | 0.94 | 0.01 | 0.06 | 0.99 | 0.75 |
| 74% RH, 38 C. | 4-19-95 9:45 AM | 312 | −0.01 | 0.05 | 0.99 | 0.75 | 0.01 | 0.06 | 0.99 | 0.93 |
| Switch to | 4-20-95 9:45 AM | 336 | −0.04 | 0.19 | 3.78 | 5.22 | −0.02 | 0.21 | 3.73 | 5.30 |
| 98% RH, 38 C. | 4-21-95 9:30 AM | 360 | −0.05 | 0.21 | 4.10 | 5.22 | −0.07 | 0.22 | 4.06 | 5.48 |
| Switch to | 4-24-95 9:45 AM | 432 | −0.10 | 0.04 | 1.97 | 2.34 | −0.09 | 0.06 | 1.93 | 2.51 |
| 74% RH, 38 C. | | | | | | | | | | |
| Switch to | 4-25-95 9:45 AM | 456 | −0.15 | −0.08 | 0.71 | 1.12 | −0.14 | −0.08 | 0.70 | 1.58 |
| 50% RH, 22 C. | 4-26-95 9:45 AM | 480 | −0.13 | −0.06 | 0.83 | 0.93 | −0.10 | −0.07 | 0.81 | 1.31 |
| Switch to | 4-27-95 11:45 AM | 506 | −0.36 | −0.58 | −4.10 | −2.98 | −0.33 | −0.59 | −4.07 | −2.69 |
| 2% RH, 70 C. | 4-28-95 11:15 AM | 530 | −0.38 | −0.62 | −4.34 | −2.89 | −0.35 | −0.61 | −4.32 | −3.25 |
| | 4-30-95 5:15 AM | 572 | −0.40 | −0.63 | −4.44 | −3.17 | −0.39 | −0.64 | −4.46 | −2.88 |
| Switch to | 5-1-95 9:45 AM | 500 | −0.28 | −0.48 | −2.28 | −1.49 | −0.27 | −0.48 | −2.32 | −1.12 |
| 50% RH, 22 C. | 5-2-95 9:30 AM | 624 | −0.22 | −0.33 | −1.26 | −1.31 | −0.19 | −0.36 | −1.31 | −0.93 |
| | 5-3-95 9:30 AM | 648 | −0.21 | −0.31 | −1.04 | −1.03 | −0.18 | −0.33 | −1.10 | −0.47 |
| | 5-4-95 9:45 AM | 672 | −0.19 | −0.28 | −0.81 | −1.03 | −0.17 | −0.29 | −0.85 | −0.74 |
| Switch to | 5-5-95 9:30 AM | 696 | −0.12 | −0.05 | 0.97 | 1.12 | −0.13 | −0.06 | 0.95 | 1.40 |
| 74% RH 38 C. | 5-8-95 9:45 AM | 768 | −0.12 | −0.04 | 1.16 | 1.31 | −0.11 | −0.05 | 1.03 | 1.49 |
| Switch to | 5-9-95 9:45 AM | 792 | −0.08 | 0.16 | 3.55 | 4.66 | −0.05 | 0.14 | 3.53 | 4.92 |
| 98% RH, 38 C. | 5-10-95 9:30 AM | 816 | −0.08 | 0.17 | 3.81 | 4.66 | −0.07 | 0.15 | 3.67 | 4.46 |
| Switch to | 5-11-95 9:45 AM | 840 | −0.15 | 0.01 | 1.87 | 2.42 | −0.11 | −0.02 | 1.87 | 2.51 |
| 74% RH, 38 C. | 5-12-95 9:30 AM | 864 | −0.15 | 0.00 | 1.92 | 2.71 | −0.15 | −0.01 | 1.78 | 2.70 |
| Switch to | 5-15-95 9:45 AM | 888 | −0.17 | −0.09 | 1.03 | 1.31 | −0.15 | −0.08 | 1.01 | 1.68 |
| 50% RH, 22 C. | | | | | | | | | | |

TABLE VI
Cyclic Humidity Data for Set 2 - Low Humidity First
Grade 92# (Old)

| | | | Change in Dimensions from Initial (%) | | | | | | | |
|---|---|---|---|---|---|---|---|---|---|---|
| | | Elapsed | Laminate 1 | | | | Laminate 2 | | | |
| Condition | Time | Time (hr) | MD | CD | Mass | Thick | MD | CD | Mass | Thick |
| Start @ | 4-3-95 | 0 | 0 | 0 | 0 | 0 | 0 | 0 | 0 | 0 |
| 50% RH, 22 C. | 4-7-95 1:30 PM | | | | | | | | | |
| Switch to | 4-8-95 9:45 AM | 47 | −0.22 | −0.50 | −3.87 | −1.99 | −0.22 | −0.53 | −4.05 | −1.65 |
| 2% RH, 70 C. | 4-9-95 2:10 PM | 76 | −0.24 | −0.58 | −4.27 | −2.50 | −0.24 | −0.60 | −4.45 | −2.38 |
| | 4-10-95 10:50 AM | 97 | −0.25 | −0.55 | −4.25 | −2.68 | −0.25 | −0.60 | −4.51 | −2.20 |
| | 4-11-95 10:30 AM | 121 | −0.25 | −0.58 | −4.28 | −3.15 | −0.26 | −0.61 | −4.57 | −2.84 |
| Switch to | 4-12-95 9:30 AM | 144 | −0.20 | −0.45 | −2.98 | −2.50 | −0.19 | −0.48 | −3.23 | −2.29 |
| 50% RH, 22 C. | 4-13-95 9:30 AM | 168 | −0.14 | −0.39 | −2.30 | −1.95 | −0.16 | −0.40 | −2.50 | −1.92 |
| | 4-17-95 9:45 AM | 264 | −0.06 | −0.20 | −0.97 | −0.65 | −0.07 | −0.22 | −1.15 | −0.18 |
| Switch to | 4-18-95 9:45 AM | 288 | 0.01 | 0.07 | 1.19 | 1.11 | 0.00 | 0.09 | 1.22 | 1.56 |
| 74% RH, 38 C. | 4-19-95 9:45 AM | 312 | −0.01 | 0.08 | 1.15 | 1.20 | 0.01 | 0.09 | 1.17 | 1.47 |
| Switch to | 4-20-95 9:45 AM | 336 | −0.02 | 0.25 | 3.98 | 4.72 | 0.00 | 0.30 | 3.70 | 4.77 |
| 98% RH, 38 C. | 4-21-95 9:30 AM | 360 | −0.04 | 0.24 | 4.27 | 5.28 | −0.02 | 0.30 | 4.13 | 5.13 |
| Switch to | 4-24-95 9:45 AM | 432 | −0.10 | 0.07 | 2.02 | 2.22 | −0.05 | 0.12 | 1.98 | 2.84 |
| 74% RH, 38 C. | | | | | | | | | | |
| Switch to | 4-25-95 9:45 AM | 456 | −0.14 | −0.06 | 0.71 | 1.11 | −0.12 | −0.05 | 0.59 | 1.47 |
| 50% RH, 22 C. | 4-26-95 9:45 AM | 480 | −0.13 | −0.07 | 0.82 | 1.30 | −0.11 | −0.04 | 0.71 | 1.10 |
| Switch to | 4-27-95 11:45 AM | 506 | −0.34 | −0.62 | −4.21 | −3.33 | −0.34 | −0.64 | −4.45 | −3.02 |
| 2% RH, 70 C. | 4-28-95 11:15 AM | 530 | −0.37 | −0.66 | −4.48 | −3.24 | −0.35 | −0.67 | −4.68 | −2.84 |
| | 4-30-95 5:15 AM | 572 | −0.33 | −0.66 | −4.58 | −3.33 | −0.36 | −0.72 | −4.83 | −3.25 |
| Switch to | 5-1-95 9:45 AM | 500 | −0.27 | −0.50 | −2.31 | −2.22 | −0.25 | −0.51 | −2.48 | −1.92 |
| 50% RH, 22 C. | 5-2-95 9:30 AM | 624 | −0.19 | −0.36 | −1.30 | −1.02 | −0.20 | −0.35 | −1.39 | −1.01 |
| | 5-3-95 9:30 AM | 648 | −0.20 | −0.33 | −1.13 | −1.58 | −0.18 | −0.33 | −1.23 | −1.00 |
| | 5-4-95 9:45 AM | 672 | −0.19 | −0.30 | −0.90 | −0.65 | −0.16 | −0.31 | −1.03 | −0.64 |
| Switch to | 5-5-95 9:30 AM | 696 | −0.10 | −0.04 | 1.09 | 0.83 | −0.08 | −0.03 | 0.03 | 1.29 |
| 74% RH, 38 C. | 5-8-95 9:45 AM | 768 | −0.02 | −0.02 | 1.19 | 1.30 | −0.08 | −0.01 | 1.03 | 1.11 |
| Switch to | 5-9-95 9:45 AM | 792 | −0.08 | 0.18 | 3.84 | 4.45 | −0.07 | 0.22 | 3.73 | 4.59 |
| 98% RH, 38 C. | 5-10-95 9:30 AM | 816 | −0.08 | 0.19 | 3.95 | 4.63 | −0.05 | 0.23 | 3.75 | 4.68 |
| Switch to | 5-11-95 9:45 AM | 840 | −0.13 | 0.03 | 2.16 | 2.50 | −0.10 | 0.07 | 1.87 | 2.57 |
| 74% RH, 38 C. | 5-12-95 9:30 AM | 864 | −0.13 | 0.03 | 2.01 | 2.50 | −0.09 | 0.06 | 1.87 | 2.58 |
| Switch to | 5-15-95 9:45 AM | 888 | −0.15 | −0.07 | 0.98 | 1.57 | −0.13 | −0.04 | 0.86 | 1.38 |
| 50% RH, 22 C. | | | | | | | | | | |

TABLE VII
Cyclic Humidity Data for Set 2 - Low Humidity First
Grade 137# (New)

| | | | Change in Dimensions from Initial (%) | | | | | | | |
|---|---|---|---|---|---|---|---|---|---|---|
| | | Elapsed | Laminate 1 | | | | Laminate 2 | | | |
| Condition | Time | Time (hr) | MD | CD | Mass | Thick | MD | CD | Mass | Thick |
| Start @ | 4-3-95 | 0 | 0 | 0 | 0 | 0 | 0 | 0 | 0 | 0 |
| 50% RH, 22 C. | 4-7-95 1:30 PM | | | | | | | | | |
| Switch to | 4-8-95 9:45 AM | 47 | −0.19 | −0.43 | −3.47 | −2.33 | −0.19 | −0.39 | −3.44 | −1.78 |
| 2% RH, 70 C. | 4-9-95 2:10 PM | 76 | −0.20 | −0.47 | −3.81 | −4.28 | −0.21 | −0.42 | −3.82 | −3.01 |
| | 4-10-95 10:50 AM | 97 | −0.21 | −0.47 | −3.80 | −3.26 | −0.22 | −0.44 | −3.87 | −2.44 |
| | 4-11-95 10:30 AM | 121 | −0.21 | −0.44 | −3.85 | −3.16 | −0.21 | −0.42 | −3.81 | −2.53 |
| Switch to | 4-12-95 9:30 AM | 144 | −0.17 | −0.32 | −2.64 | −2.70 | −0.16 | −0.33 | −2.66 | −1.97 |
| 50% RH, 22 C. | 4-13-95 9:30 AM | 168 | −0.13 | −0.28 | −2.01 | −2.05 | −0.12 | −0.26 | −2.03 | −1.41 |
| | 4-17-95 9:45 AM | 264 | −0.06 | −0.17 | −0.86 | −0.93 | −0.08 | −0.16 | −0.87 | −0.10 |
| Switch to | 4-18-95 9:45 AM | 288 | −0.04 | 0.02 | 1.06 | 0.56 | −0.02 | 0.05 | 1.04 | 1.22 |
| 74% RH, 38 C. | 4-19-95 9:45 AM | 312 | −0.03 | 0.03 | 1.08 | 0.56 | −0.02 | 0.02 | 0.99 | 1.13 |
| Switch to | 4-20-95 9:45 AM | 336 | −0.12 | 0.12 | 4.63 | 6.24 | −0.13 | 0.14 | 4.64 | 7.22 |
| 98% RH, 38 C. | 4-21-95 9:30 AM | 360 | −0.13 | 0.10 | 5.10 | 6.41 | −0.14 | 0.13 | 4.98 | 6.85 |
| Switch to | 4-24-95 9:45 AM | 432 | −0.18 | −0.04 | 2.39 | 2.89 | −0.17 | −0.05 | 2.34 | 3.57 |
| 74% RH, 38 C. | | | | | | | | | | |
| Switch to | 4-25-95 9:45 AM | 456 | −0.22 | −0.18 | 1.04 | 1.40 | −0.22 | −0.16 | 1.03 | 2.35 |
| 50% RH, 22 C. | 4-26-95 9:45 AM | 480 | −0.21 | −0.17 | 1.16 | 1.77 | −0.20 | −0.15 | 1.17 | 2.26 |
| Switch to | 4-27-95 11:45 AM | 506 | −0.39 | −0.62 | −3.80 | −2.89 | −0.38 | −0.59 | −3.80 | −2.16 |
| 2% RH, 70 C. | 4-28-95 11:15 AM | 530 | −0.38 | −0.64 | −4.01 | −2.89 | −0.39 | −0.63 | −3.99 | −2.54 |
| | 4-30-95 5:15 AM | 572 | −0.40 | −0.67 | −4.06 | −2.70 | −0.41 | −0.64 | −4.04 | −2.16 |
| Switch to | 5-1-95 9:45 AM | 500 | −0.31 | −0.50 | −1.87 | −0.75 | −0.30 | −0.48 | −1.85 | −0.29 |
| 50% RH, 22 C. | 5-2-95 9:30 AM | 624 | −0.28 | −0.38 | −0.93 | −0.46 | −0.26 | −0.37 | −0.93 | 0.10 |
| | 5-3-95 9:30 AM | 648 | −0.26 | −0.37 | −0.76 | −0.37 | −0.26 | −0.35 | −0.76 | 0.28 |
| | 5-4-95 9:45 AM | 672 | −0.23 | −0.34 | −0.55 | −0.37 | −0.24 | −0.34 | −0.56 | 0.29 |
| Switch to | 5-5-95 9:30 AM | 696 | −0.19 | −0.15 | 1.33 | 1.69 | −0.21 | −0.13 | 1.25 | 2.05 |
| 74% RH, 38 C. | 5-8-95 9:45 AM | 768 | −0.20 | −0.15 | 1.36 | 1.68 | −0.18 | −0.13 | 1.34 | 2.16 |
| Switch to | 5-9-95 9:45 AM | 792 | −0.19 | 0.03 | 4.47 | 5.59 | −0.17 | 0.07 | 4.53 | 6.38 |
| 98% RH, 38 C. | 5-10-95 9:30 AM | 816 | −0.19 | 0.05 | 4.63 | 5.59 | −0.19 | 0.06 | 4.48 | 5.91 |
| Switch to | 5-11-95 9:45 AM | 840 | −0.24 | −0.11 | 2.24 | 2.79 | −0.22 | −0.09 | 2.24 | 3.47 |
| 74% RH, 38 C. | 5-12-95 9:30 AM | 864 | −0.24 | −0.15 | 2.17 | −2.50 | −0.23 | −0.10 | 2.20 | 3.28 |
| Switch to | 5-15-95 9:45 AM | 888 | −0.25 | −0.16 | 1.37 | 2.24 | −0.23 | −0.16 | 1.36 | 2.72 |
| 50% RH, 22 C. | | | | | | | | | | |

TABLE VIII
Cyclic Humidity Data for Set 2 - Low Humidity First
Grade 137# (Old)

| | | | Change in Dimensions from Initial (%) | | | | | | | |
|---|---|---|---|---|---|---|---|---|---|---|
| | | Elapsed | Laminate 1 | | | | Laminate 2 | | | |
| Condition | Time | Time (hr) | MD | CD | Mass | Thick | MD | CD | Mass | Thick |
| Start @ | 4-3-95 | 0 | 0 | 0 | 0 | 0 | 0 | 0 | 0 | 0 |
| 50% RH, 22 C. | 4-7-95 1:30 PM | | | | | | | | | |
| Switch to | 4-8-95 9:45 AM | 47 | −0.18 | −0.48 | −3.76 | −1.84 | −0.21 | −0.49 | −3.79 | −2.77 |
| 2% RH, 70 C. | 4-9-95 2:10 PM | 76 | −0.21 | −0.52 | −4.16 | −2.03 | −0.22 | −0.52 | −4.12 | −3.05 |
| | 4-10-95 10:50 AM | 97 | −0.21 | −0.51 | −4.18 | −2.03 | −0.21 | −0.51 | −4.18 | −2.03 |
| | 4-11-95 10:30 AM | 121 | −0.21 | −0.51 | −4.20 | −2.99 | −0.24 | −0.51 | −4.22 | −3.43 |
| Switch to | 4-12-95 9:30 AM | 144 | −0.16 | −0.42 | −2.99 | −1.74 | −0.16 | −0.42 | −2.98 | −2.67 |
| 50% RH, 22 C. | 4-13-95 9:30 AM | 168 | −0.13 | −0.37 | −2.35 | −1.45 | −0.13 | −0.35 | −2.31 | −2.00 |
| | 4-17-95 9:45 AM | 264 | −0.08 | −0.21 | −1.11 | −0.10 | −0.11 | −0.19 | −1.08 | −0.95 |
| Switch to | 4-18-95 9:45 AM | 288 | −0.02 | 0.02 | 1.11 | 1.84 | −0.03 | 0.04 | 1.04 | 1.05 |
| 74% RH, 38 C. | 4-19-95 9:45 AM | 312 | −0.02 | 0.02 | 1.05 | 1.84 | −0.04 | 0.05 | 1.12 | 1.24 |
| Switch to | 4-20-95 9:45 AM | 336 | −0.09 | 0.16 | 4.41 | 6.48 | −0.11 | 0.17 | 4.49 | 5.43 |
| 98% RH, 38 C. | 4-21-95 9:30 AM | 360 | −0.11 | 0.14 | 4.72 | 6.57 | −0.13 | 0.14 | 4.75 | 5.62 |
| Switch to | 4-24-95 9:45 AM | 432 | −0.14 | −0.02 | 2.19 | 3.77 | −0.18 | −0.02 | 2.11 | 2.86 |
| 74% RH, 38 C. | | | | | | | | | | |
| Switch to | 4-25-95 9:45 AM | 456 | −0.19 | −0.17 | 0.78 | 2.23 | −0.22 | −0.14 | 0.80 | 1.33 |
| 50% RH, 22 C. | 4-26-95 9:45 AM | 480 | −0.18 | −0.16 | 0.90 | 2.23 | −0.20 | −0.14 | 0.93 | 1.34 |
| Switch to | 4-27-95 11:45 AM | 506 | −0.35 | −0.67 | −4.07 | −2.03 | −0.35 | −0.64 | −4.13 | −3.15 |
| 2% RH, 70 C. | 4-28-95 11:15 AM | 530 | −0.36 | −0.69 | −4.29 | −2.22 | −0.41 | −0.69 | −4.36 | −3.05 |
| | 4-30-95 5:15 AM | 572 | −0.38 | −0.72 | −4.45 | −2.41 | −0.39 | −0.69 | −4.41 | −3.05 |
| Switch to | 5-1-95 9:45 AM | 500 | −0.30 | −0.55 | −2.21 | −0.87 | −0.33 | −0.51 | −2.16 | −1.34 |
| 50% RH, 22 C. | 5-2-95 9:30 AM | 624 | −0.24 | −0.43 | −1.22 | −0.29 | −0.27 | −0.40 | −1.17 | −0.86 |
| | 5-3-95 9:30 AM | 648 | −0.23 | −0.41 | −1.07 | −0.39 | −0.26 | −0.39 | −1.03 | −0.29 |
| | 5-4-95 9:45 AM | 672 | −0.23 | −0.39 | −0.85 | 0.20 | −0.23 | −0.36 | −0.81 | −0.29 |
| Switch to | 5-5-95 9:30 AM | 696 | −0.16 | −0.15 | 1.04 | 2.03 | −0.20 | −0.12 | 1.17 | 1.63 |
| 74% RH, 38 C. | 5-8-95 9:45 AM | 768 | −0.15 | −0.14 | 1.24 | 2.71 | −0.20 | −0.11 | 1.23 | 1.82 |
| Switch to | 5-9-95 9:45 AM | 792 | −0.14 | 0.06 | 4.29 | 6.29 | −0.17 | 0.07 | 4.21 | 5.15 |
| 98% RH, 38 C. | 5-10-95 9:30 AM | 816 | −0.15 | 0.07 | 4.37 | 6.29 | −0.18 | 0.09 | 4.37 | 5.43 |
| Switch to | 5-11-95 9:45 AM | 840 | −0.19 | −0.09 | 2.06 | 3.48 | −0.22 | −0.08 | 2.15 | 2.77 |
| 74% RH, 38 C. | 5-12-95 9:30 AM | 864 | −0.20 | −0.10 | 2.05 | 3.87 | −0.22 | −0.08 | 2.04 | 2.96 |
| Switch to | 5-15-95 9:45 AM | 888 | −0.22 | −0.19 | 1.09 | 2.61 | −0.22 | −0.15 | 1.12 | 1.62 |
| 50% RH, 22 C. | | | | | | | | | | |

### Results for Set 2 Laminates Exposed to Low Humidity First

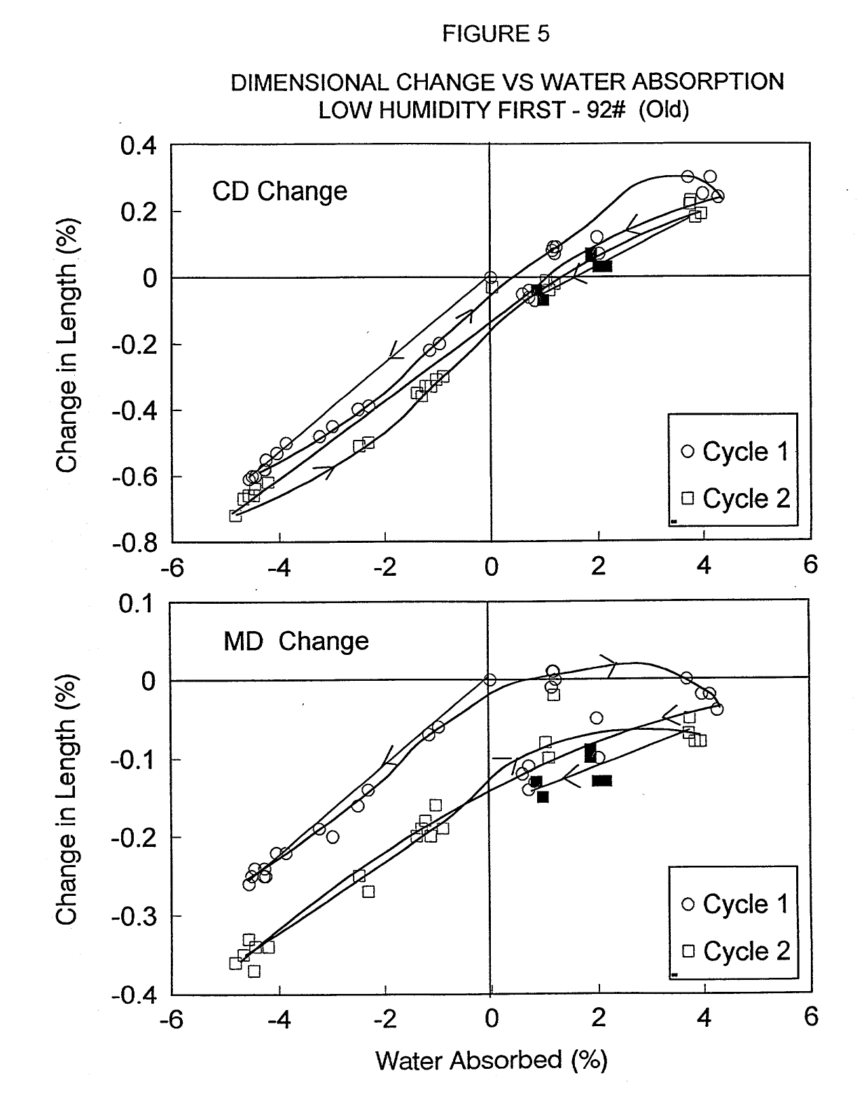

FIGS. 5 through 8 show the dimensional change versus water absorbed/desorbed for Set 2 laminates that were exposed to low humidity first (data given respectively in Tables V-VIII).

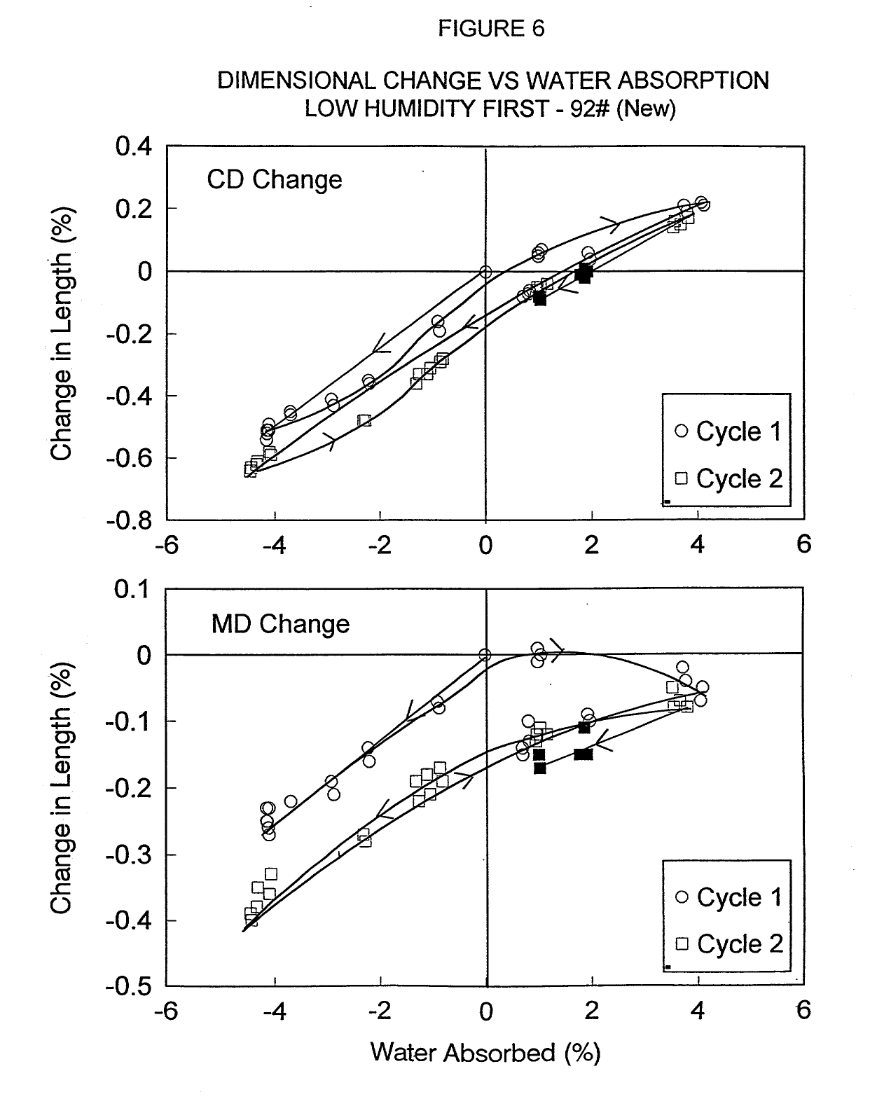

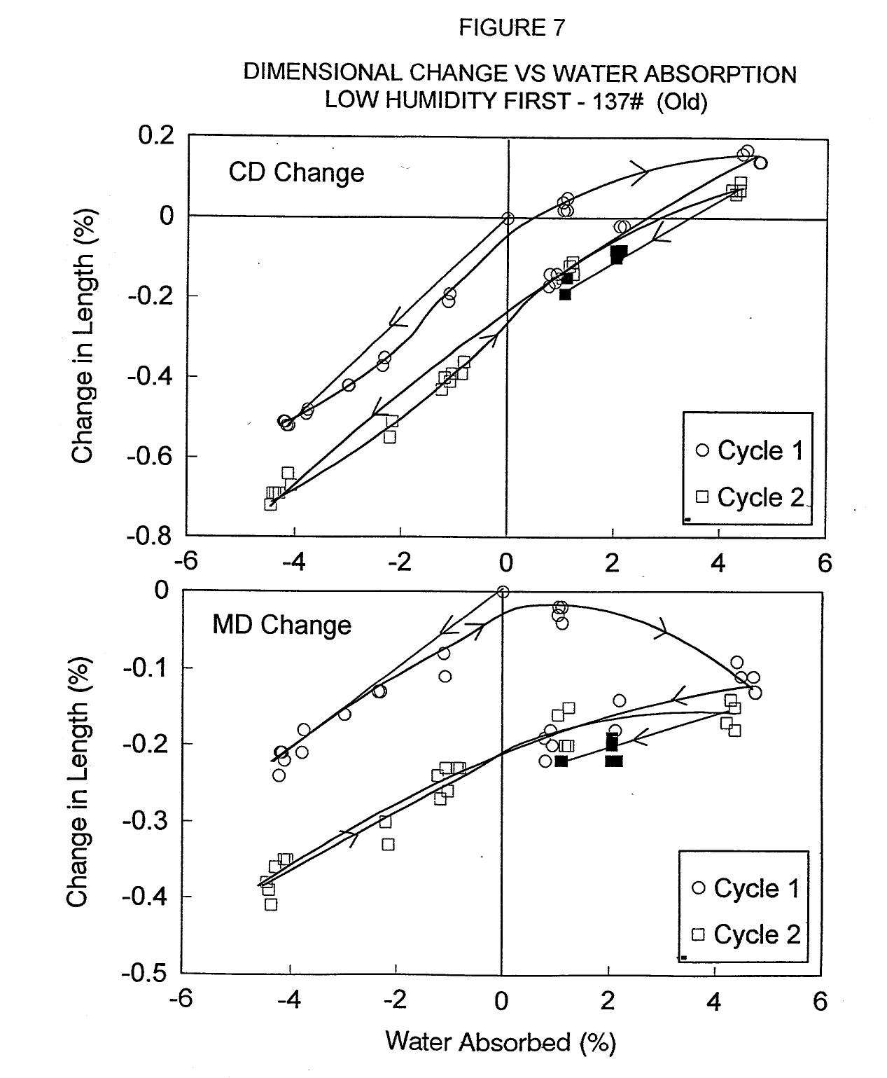

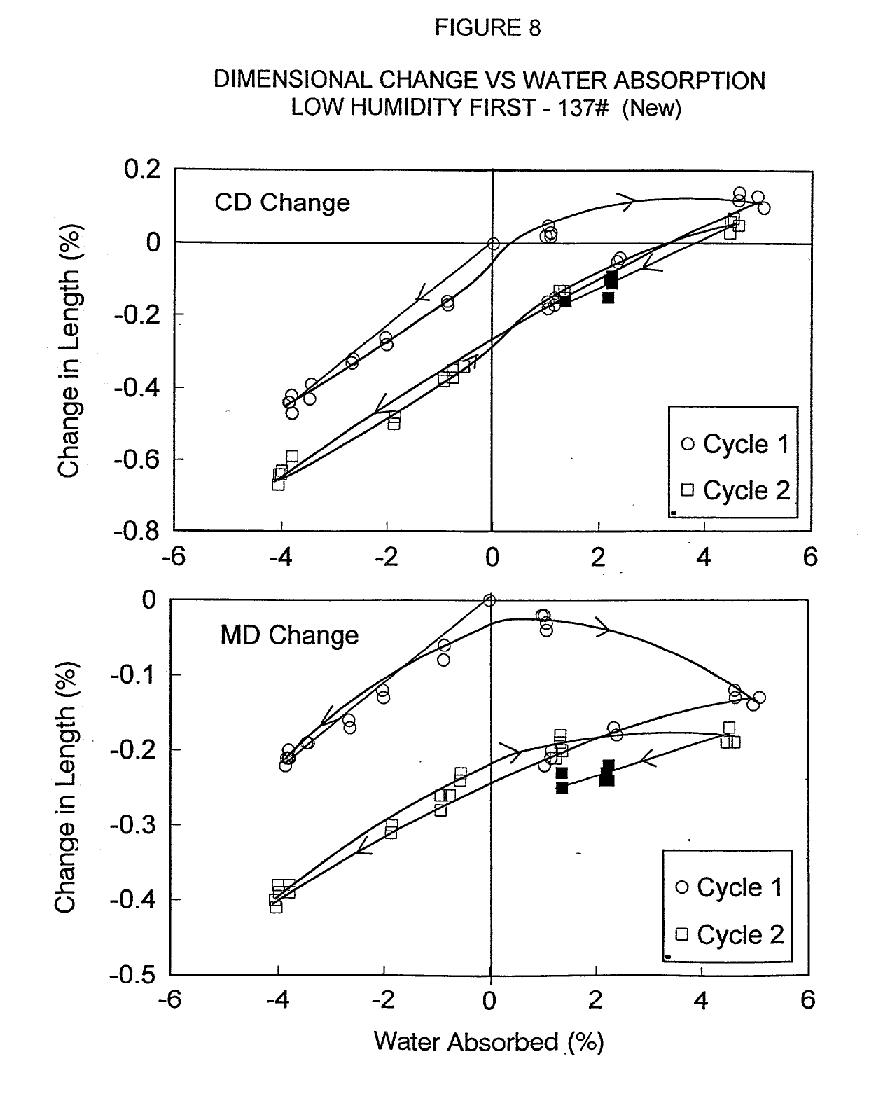

The CD and MD plots shown in FIGS. 5-8 show that the relationship between water absorption and dimensional change is close to linear for contractions and expansions resulting from the first low and high humidity exposures. After this first low-high humidity cycle, the laminates behave in a similar manner to Set 1 laminates in that they expand moderately in the CD and expand then contract in the MD. The 92# plots (FIGS. 5 and 6) are somewhat different from the 137# CD plots grade (FIGS. 7 and 8) in that a more pronounced contraction occurs in the laminates during high humidity exposure of the 137#, especially in the MD. This is apparent from the split that occurs between the curves of the two cycles in the CD and MD plots of FIGS. 7 and 8. The MD plots are interesting because after the linear contraction/expansion that occurs during the initial low humidity exposure and subsequent return to 50% humidity, the plots are very similar to those of the MD change of the Set 1 laminates that underwent high humidity exposure first. This curve showing the laminate expansion/contraction at high humidity is unique to the first high humidity exposure and is not repeated during subsequent high humidity exposures. The Set 2 laminates shrink little after the initial low humidity exposure but shrink considerably after the subsequent high humidity exposure. Like Set 1, they do not return to their initial dimensions even though they do return to their original mass at 50% RH.

A comparison of the plots shown for the four grades (FIGS. 5 through 8) is similar to the comparison made for Set 1 laminates. The 137# grades (FIGS. 7 and 8) have more severe expansion-contraction during their first high humidity cycle and more severe curvature and corresponding shrinkage at 50% RH than the 92# grade (FIGS. 5 and 6). Contrary to the Set 1 plots, the high humidity curvature and subsequent shrinkage does not appear to be greater for the “New” laminates (FIGS. 5 and 7) versus the “Old” laminates (FIGS. 6 and 8).

The results from the Set 2 study can be best summarized by stating that the laminates show a linear relationship between water absorbed and contraction/expansion during the initial low-humidity exposure and subsequent humidity increase to 50% RH. The laminate dimensional pattern during the following high-low-high humidity exposures then resemble the pattern noted for the Set 1 laminates that were exposed to high humidity first. For the most part, the Set 2 laminates behaved in a manner consistent to the Set 1 laminates.

The most interesting result of these cyclic humidity studies continues to be that the dimensions of laminates that have been exposed to high humidity (i.e., greater than about 65% RH) and then returned to 50% RH are different than the original laminate dimensions measured at 50% RH. In other words, the laminate does not return to its original dimensions after being exposed to high humidity. Such treatment, therefore, serves to break, or substantially reduce, the shrinkage/expansion effect on the CD and MD dimensions of the laminate resulting from subsequent cyclical exposures to high humidity. Thus, improving the dimensional stability of the laminate. As a result of the invention post-lamination treatment, shrinkage of the laminate in the CD and MD directions is reduced by at least 30%.

TABLE IX

| | | | | | |
|---|---|---|---|---|---|
| (New) | | | | | |
| Laminate | | Humidity^{(a)} | Change from | Initial | Dimensions (%) |
| Sample | Set | Cycle | Mass | CD | MD |

| | | | | | |
|---|---|---|---|---|---|
| 92# | 1 | High | 0.00 | −0.19 | −0.14 |
| | | High-Low | 0.00 | −0.23 | −0.13 |
| 92# | 2 | Low | 0.00 | −0.09 | −0.07 |
| | | Low-High | 0.00 | −0.18 | −0.17 |
| 137# | 1 | High | 0.00 | −0.22 | −0.27 |
| | | High-Low | 0.00 | −0.30 | −0.23 |
| 137# | 2 | Low | 0.00 | −0.05 | −0.05 |
| | | Low-High | 0.00 | −0.27 | −0.25 |

^{(a)}High = After one-half of Set 1 cycle
High-Low = After one Set 1 cycle
Low = After one-half of Set 2 cycle
Low-High = After one Set 2 cycle

Table IX shows, in tabular form, the laminate shrinkage estimated from FIGS. 1-8 that can be expected after the high and low humidity exposures of the laminates (only the data for the “New” laminates are shown). In the first entry for the 92# grade, the CD and MD dimensional change of Set 1 laminate is given after the high humidity exposure only, which is one-half the cycle, and after the high and low humidity exposures equivalent to one full cycle. The corresponding entries for Set 2 and for the 137# grade follow. The mass change is given as zero for all the entries because that is the reference point at which the dimensions are being read from the graph.

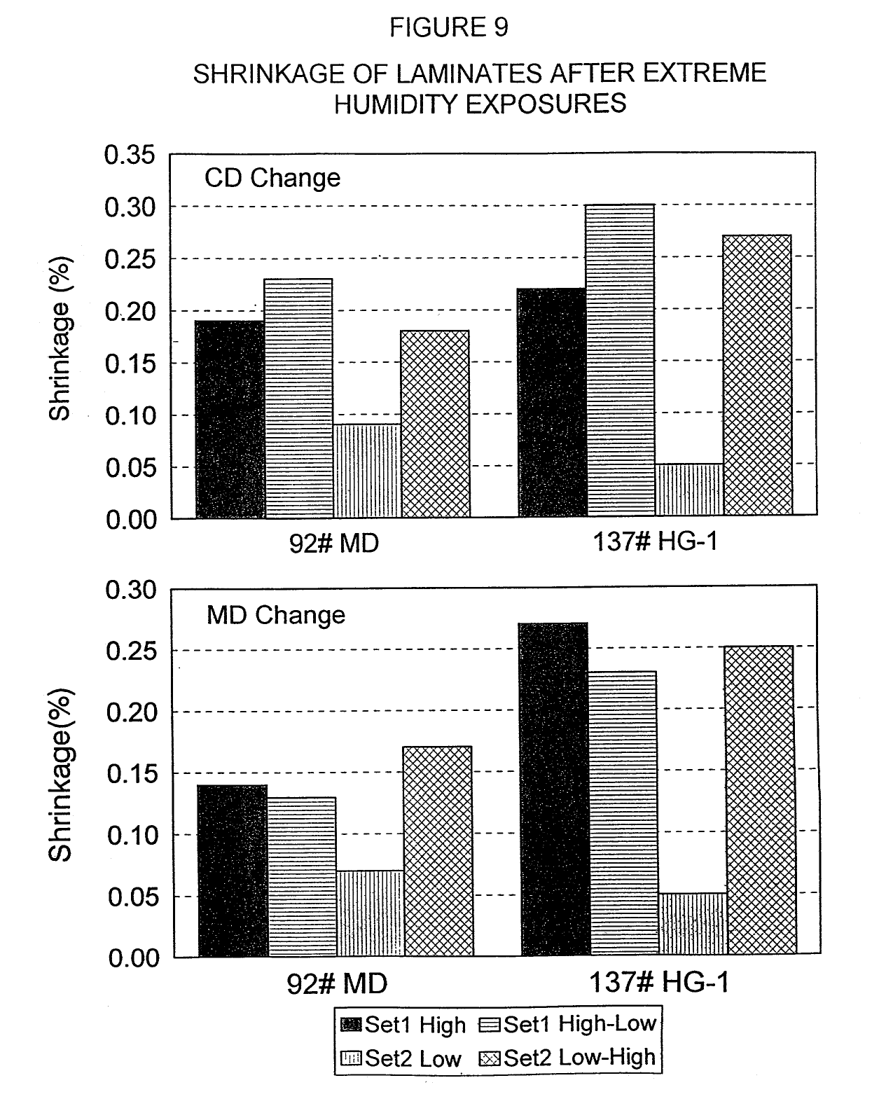

Finally, FIG. 9 is a graphical interpretation of the data presented in Table IX. The greatest shrinkage, in both the CD and MD, occurred in the 137# grade. For both laminate grades, the greatest shrinkage occurred in exposures that included high humidity exposures. Less shrinkage was noted after the low humidity exposure. We can, therefore, conclude, as was already surmised when discussing FIGS. 1 through 8, that the high humidity exposure appears to be responsible for the laminate shrinkage observed.

This data answers in the affirmative the most important question which was the objective of this study, i.e., whether conditioning a laminate at high humidity to induce the initial shrinkage noted above will result in a laminate that will undergo less dimensional change over its lifetime. Therefore, a laminate of improved dimensional stability can be produced by preconditioning the laminate for exposure to environmental conditions by subjecting the laminate to high humidity (>65%) at relatively low temperature (32°-45° C.) prior to exposure to ambient conditions. As earlier noted, such treatment serves to break, or substantially reduce, the shrinkage/expansion effect on the CD and MD dimensions of the laminate resulting from subsequent cyclical exposures to high humidity. Thus, improving the dimensional stability of the laminate. As a result of the invention post-lamination treatment, shrinkage of the laminate in the CD and MD directions is reduced by at least 30%.

The subject matter of the disclosed invention is considered to be:

(1) A laminate comprising multiple layers of paper having been impregnated with a polymeric resin and pressed together under high pressure and high temperature to cure the resin, followed by preconditioning the laminate by subjecting the laminate to a first humidity of greater than about 65% and a temperature of from about 32° C. to about 45° C., and then drying the laminate before exposure to ambient conditions wherein said laminate is characterized by a reduced shrinkage in the laminate cross direction and machine direction upon subsequent exposure to cyclical humidity variations as compared to a laminate manufactured in the absence of the preconditioning;

(2) the laminate of (1) wherein the exposure to ambient conditions occurs for a period greater than 24 hours at atmospheric pressure;

(3) the laminate of (2) wherein the exposure occurs for a period greater than 48 hours at atmospheric pressure;

(4) the laminate of (1) wherein the humidity is greater than 75% and the temperature is from about 36° C. to about 40° C.;

(5) the laminate of (4) wherein the humidity is greater than 90% and the temperature is about 38° C.;

(6) the laminate of (1) wherein the laminate is selected from the group of laminates consisting of industrial and decorative laminates;

(7) the laminate of (6) wherein a topmost layered sheet is a decorative sheet and the laminate is a decorative laminate;

(8) the laiminate of (6) wherein the laminate is an industrial laminate;

(9) the laminate of (1) wherein the reduction in shrinkage is at least 30%; and

(10) the laminate of (9) wherein the reduction in shrinkage is at least 50%; as well as

(11) A method for manufacturing a laminate comprising the steps of:

(a) impregnating multiple layers of paper with a polymeric resin;

(b) pressing said layers together under high pressure and high temperature to cure the resin and form the laminate; and

(c) preconditioning the laminate by subjecting the laminate to a humidity of greater than about 65% and a temperature of from about 32° C. to about 45° C., followed by drying the laminate before exposure;

(12) the method of (11) wherein the exposure to ambient conditions occurs for a period greater than 24 hours at atmospheric pressure;

(13) the method of (12) wherein the exposure occurs for a period greater than 48 hours at atmospheric pressure;

(14) the method of (1) wherein the humidity is greater than 75% and the temperature is from about 36° C. to about 40° C.;

(15) the method of (14) wherein the humidity is greater than 90% and the temperature is about 38° C.;

(16) the method of (11) wherein the laminate is selected from the group of laminates consisting of industrial and decorative laminates;

(17) the method of (16) wherein a topmost layered sheet is a decorative sheet and the laminate is a decorative laminate;

(18) the method of (16) wherein the laminate is an industrial laminate;

(19) the laminate of (11) wherein the reduction in shrinkage is at least 30%; and

(20) the laminate of (19) wherein the reduction in shrinkage is at least 50%.

What is claimed is:

1. A laminate comprising multiple layers of paper having been impregnated with a polymeric resin and pressed together under high pressure and high temperature to cure the resin, followed by preconditioning the laminate by subjecting the laminate to a first humidity of greater than about 65% and a temperature of from about 32° C. to about 45° C., and then drying the laminate before exposure to ambient conditions wherein said laminate is characterized by a reduced shrinkage in the laminate cross direction and machine direction upon subsequent exposure to cyclical humidity variations as compared to a laminate manufactured in the absence of the preconditioning.

2. The laminate of claim 1 wherein the exposure to ambient conditions occurs for a period greater than 24 hours at atmospheric pressure.

3. The laminate of claim 2 wherein the exposure occurs for a period greater than 48 hours at atmospheric pressure.

4. The laminate of claim 1 wherein the humidity is greater than 75% and the temperature is from about 36° C. to about 40° C.

5. The laminate of claim 4 wherein the humidity is greater than 90% and the temperature is about 38° C.

6. The laminate of claim 1 wherein the laminate is selected from the group of laminates consisting of industrial and decorative laminates.

7. The laminate of claim 6 wherein a topmost layered sheet is a decorative sheet and the laminate is a decorative laminate.

8. The laiminate of claim 6 wherein the laminate is an industrial laminate.

9. The laminate of claim 1 wherein the reduction in shrinkage is at least 30%.

10. The laminate of claim 9 wherein the reduction in shrinkage is at least 50%.

11. A method for manufacturing a laminate comprising the steps of:
(a) impregnating multiple layers of paper with a polymeric resin;
(b) pressing said layers together under high pressure and high temperature to cure the resin and form the laminate; and
(c) preconditioning the laminate by subjecting the laminate to a humidity of greater than about 65% and a temperature of from about 32° C. to about 45° C., followed by drying the laminate before exposure.

12. The method of claim 11 wherein the exposure to ambient conditions occurs for a period greater than 24 hours at atmospheric pressure.

13. The method of claim 12 wherein the exposure occurs for a period greater than 48 hours at atmospheric pressure.

14. The method of claim 11 wherein the humidity is greater than 75% and the temperature is from about 36° C. to about 40° C.

15. The method of claim 14 wherein the humidity is greater than 90% and the temperature is about 38° C.

16. The method of claim 11 wherein the laminate is selected from the group of laminates consisting of industrial and decorative laminates.

17. The method of claim 16 wherein a topmost layered sheet is a decorative sheet and the laminate is a decorative laminate.

18. The method of claim 16 wherein the laminate is an industrial laminate

19. The laminate of claim 11 wherein the reduction in shrinkage is at least 30%.

20. The laminate of claim 19 wherein the reduction in shrinkage is at least 50%.
